(19) United States
(12) Patent Application Publication
(10) Pub. No.: US 2026/0072656 A1
(43) Pub. Date: Mar. 12, 2026

(54) ARCHITECTURE AS CODE TO INFRASTRUCTURE AS CODE

(71) Applicant: JPMorgan Chase Bank, N.A., NEW YORK, NY (US)

(72) Inventor: Keith Weisel, Nolensville, TN (US)

(73) Assignee: JPMorgan Chase Bank, N.A., NEW YORK, NY (US)

(21) Appl. No.: 19/301,502

(22) Filed: Aug. 15, 2025

Related U.S. Application Data
(60) Provisional application No. 63/685,214, filed on Aug. 20, 2024.

(51) Int. Cl. G06F 8/35; G06F 8/41; G06F 40/20

(52) U.S. Cl. CPC G06F 8/35; G06F 8/427; G06F 40/20

(57) ABSTRACT

Provided is a cloud management platform, including modular components. Each component includes its own application programming interface (API), ensuring seamless integration and customization of infrastructure management capabilities. The components include an input interface, an architect generative pre-trained transformer (AGPT) assistant, a model parser, a code template repository, a mapping engine, a monitoring service, an artificial intelligence (AI)/machine learning (ML)/large language model (LLM) analytics engine, an automated detection and remediation engine, and a chaos testing service application.

### CROSS REFERENCE TO RELATED APPLICATION

This application claims benefit to U.S. Provisional Patent Application No. 63/685,214, filed Aug. 20, 2024, the disclosure is incorporated herein by reference in its entirety.

### FIELD OF TECHNOLOGY

The present disclosure generally relates to cloud computing. More particularly, the present disclosure relates to a robust, scalable, intelligent, and adaptive cloud computing infrastructure.

### BACKGROUND

In the rapidly evolving world of cloud computing, enterprises need solutions that are not only robust and scalable but also intelligent and adaptive. Enterprises face significant challenges when creating (e.g., writing architecture) and managing multi-cloud or supercloud environments. As understood by those of skill in the art, supercloud is the agnostic ability to go to any of the major public cloud service providers, such as Amazon Web Services™ (AWS), Microsoft Azure™, and Google Cloud Platform™ (GCP) without vendor lock-in. Vendor lock-in restricts flexibility, increases costs, and prevents leveraging the best features from different providers.

For enterprises preparing for supercloud capabilities, the focus should be on understanding the importance of cross-cloud services, the architecture that supports such an environment, and the networking considerations vital for the seamless integration of cloud services. Superclouds enable the movement of workloads such as applications and virtual machines to move across various cloud (e.g. AWS™, Google Cloud™, etc.) environments without the need for reconfiguration or state re-synchronization. The industry suggests that success in adopting supercloud capabilities requires a strategic approach to architecture, platform choices, and networking solutions to overcome the challenges of cloud chaos and leverage the full potential of cloud services.

Using conventional approaches, newly written architecture is structured for a specific platform architecture. The architecture solution is created in static form and provided to an engineering team for interpretation. From a software development lifecycle (SDLC) perspective, the solution architecture represents business requirements. These business requirements are translated by humans into architectural requirements that ultimately represent the interests of stakeholders. The challenge with this process, however, is that traceability is lost. That is, the diverse skill sets required by engineers to support heterogeneous cloud deployments across multiple providers create operational complexities and inefficiencies.

The use of artificial intelligence (AI)/machine learning (ML) has become of great interest for applications in practically all technologies. This includes generative pre-trained transformers. A generative pre-trained transformer is the architecture underlying large language models. Transformers are made up of many iterations of attention and multilevel perceptron layers wherein information is shared among nodes of an attention layer and passed to a multilayer perceptron layer. Interactions between and among attention layers and multilayer perceptron layers amount to multiple matrix mathematical operations of a complexity representing billions if not trillions of operations. Facts are not stored per se but associations are made among content (e.g., text or portions of text) resulting in a vector pointing in a direction in n-space.

These associations are recognized by an AI/ML model, which generates piece-by-piece content (e.g., word-by-word content). While AI can be very helpful, it can also produce what are known as hallucinations, or faulty results.

### SUMMARY

Given the aforementioned, deficiencies, what is needed are systems and methods that provide a platform designed to transform how various financial teams can deploy and manage evolutionary cloud infrastructure. What is also needed are methods and systems that can provide a unified framework for architecture as code (AaC) with supporting metadata, enabling the creation of a single AaC definition. The embodiments herein use the power of AI driven cloud solutions to leverage state-of-the-art data analytics, ML, and generative AI (GenAI) to bridge the gap between architectural models and production-ready cloud deployments. This end-to-end solution ensures that cloud infrastructure is not only accurately generated but also optimized for performance, security, and scalability.

The embodiments provide a unified framework for AaC that then serves as the source-of-truth for the ongoing end-to-end self-healing capability within cloud environments. When incidents are detected through an AI analytics engine or created through a chaos testing service, the embodiments initiate autonomous self-healing mechanisms. These mechanisms capture changes in the AaC and promote those changes through to production, thereby lowering mean time to recovery (MTTR) lead times and casing the burden on engineering teams.

From the perspective of a simplified use case, embodiments of the present disclosure provide an ability to aggregate business requirements, aggregating them as AaC. The AaC can be rendered into models providing a framework for conversation. The AaC (e.g., mainly data and metadata) can be quickly changed and used to re-render the model, in real-time. Once an agreement is achieved on all stakeholder requirements, on the backend, infrastructure engineers are working on a decoupled pattern of infrastructure-as-code (IaC) where it is parsed into JavaScript™ Object Notation (JSON) in a usable format using the metadata-rich AaC from JSON for mapping into the patterns of IaC, as depicted in FIGS. 1A and 1B below.

Embodiments of the disclosure provide a modular design. Plug-and-Play components are designed such that each component as a standalone module that can be easily integrated or replaced. This allows flexibility in choosing technologies and workflows based on specific use cases. Interfaces and application programming interfaces (APIs) are clearly defined and APIs for each module ensure interoperability and case of integration.

Embodiments of the disclosure also provide configurability. Configuration Management is provided through the use of configuration files or management tools to allow customization of workflows and component interactions without altering the core codebase. Environment-specific API configurations enable different configurations for development, testing, and production environments to cater to diverse requirements.

The embodiments also provide technology agnosticism. Abstract layers are implemented to separate the core logic from underlying technologies, making it easier to switch technologies (e.g., switching from Kafka™ to RabbitMQ™) without significant refactoring. Adapters and connectors are developed for different technologies, allowing users to plug in their preferred tools and services. Community and extensibility are facilitated via an OpenAPI Specification to facilitate integration with external tools and services. A plug-and-play system is introduced that allows developers to extend or modify the functionality of the embodiments without altering the core system.

Documentation and best practices are provided through comprehensive documentation, guidelines, and templates to help users understand and implement best practices while still allowing flexibility in their choices. Sample implementations are offered for various scenarios, showing how to customize and extend the platform.

One exemplary embodiment of the present disclosure includes a cloud management platform, comprising modular components, each with its API, ensuring seamless integration and customization of infrastructure management capabilities.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1A illustrates part 1 of a high-level architecture block diagram of a multi-cloud management platform, including key components in accordance with one or more embodiments of the present disclosure.

FIG. 1B illustrates part 2 of the high-level architecture block diagram of FIG. 1A.

FIG. 2 illustrates an exemplary process model in accordance with the embodiments.

FIG. 3 illustrates an AaC processing pipeline in accordance with the embodiments.

FIG. 4 illustrates a more detailed view of the operations of the model parser and the Mapping Engine of FIGS. 1A and 1B.

FIG. 5 illustrates an exemplary code template repository interaction noted in the mapping engine depicted in FIG. 4.

FIG. 6 illustrates an exemplary self-healing application and a chaos testing application in accordance with the embodiments.

FIG. 7 illustrates an exemplary block diagram of a system including an input interface in accordance with the embodiments

FIG. 8 illustrates a detailed view of the architect generative pre-trained transformer (AGPT) assistant, depicted in FIG. 7, in accordance with the embodiments.

FIG. 9 illustrates a detailed view of the model parser, depicted in FIG. 7, in accordance with the embodiments.

FIG. 10 illustrates a block diagram of the code template repository depicted in FIGS. 1A and 1B.

FIG. 11 illustrates a more detailed view of the mapping engine depicted in FIGS. 1A/1B in accordance with the embodiments.

FIG. 12 illustrates an exemplary monitoring and data collection service application in accordance with the embodiments.

FIG. 13A illustrates an exemplary AI/ML/large language model (LLM) analytics engine according to the embodiments.

FIG. 13B illustrates a more detailed view of components within the AI/ML/LLM analytics engine depicted in FIG. 13A.

FIG. 13C illustrates a more detailed view of the LLM system depicted in FIG. 13B

FIG. 14 illustrates an exemplary automated detection and remediation engine in accordance with the embodiments.

FIG. 15 illustrates an exemplary chaos testing service application in accordance with the embodiments.

FIG. 16 illustrates a use case flow diagram of the exemplary multi-cloud management platform depicted in FIG. 1.

FIG. 17 is a block diagram of an exemplary computing device configured for implementing one or more embodiments of the present disclosure.

Reference numerals have been carried forward.

### DETAILED DESCRIPTION

This disclosure describes systems, apparatuses, and methods related to multi-cloud platform management.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that software, process, electrical, and structural changes may be made without departing from the scope of the present disclosure.

AaC is the practice of defining architectural models using code, allowing for version control, automated validation, and consistency. In other words, AaC is the codification of architecture. Infrastructure as Code (IaC) refers to managing and provisioning computing infrastructure through machine-readable scripts rather than manual processes. AaC and IaC are related but represent different concepts within automated system management. IaC focuses on automating the provisioning and management of information technology (IT) (e.g., virtual machines, networks, storage and databases). Infrastructure configuration presented as code allows for version control, automation and reproducibility. IaC may define a desired state of infrastructure in declarative configuration files that may be automatically provisioned and used to manage resources. One goal of IaC centers around ensuring consistency, repeatability and scalability of infrastructure deployments.

AaC extends principles of IaC to encompass architectural design and governance of an entire system. AaC involves defining high level architectural decisions. AaC allows for continuous integration and continuous delivery/deployment (CI/CD) pipelines to be applied to architecture service interaction, communication patterns, security policies and deployment strategies, directly in code.

The transition from AaC to IaC involves converting these architectural definitions into executable scripts that deploy the necessary infrastructure. This process ensures that architectural designs are directly and accurately implemented in the infrastructure, promoting automation, repeatability, and scalability in cloud environments.

This framework allows enterprises to parse the AaC and map it to an appropriate cloud provider based on the enterprise's defined workload placement strategy. The platform offers real-time composable architecture for portability across cloud providers, reducing the skills gap and operational burden on engineers.

The embodiments of the present disclosure integrate multiple domains to offer comprehensive cloud management including a composable cloud along with self-healing operations. The composable cloud includes a unified framework for AaC that establishes standards and uses a flexible domain-specific language (DSL) to support various architectures. An integration with application code capability embeds infrastructure definitions within application repositories and provides libraries and APIs. Modular components utilize dynamic management tools for adaptable modularity.

The meaning of self-healing includes AI-driven optimization, that is, employing AI to optimize Platform resource allocation and the scaling of those resources based on real-time metrics. Self-healing mechanisms are provided to automatically detect and remedy issues to maintain system (system as used herein throughout meaning platform and/cloud environment) stability. When incidents are detected or created, changes are captured in the AaC and promoted through production. Advanced monitoring and analytics provide predictive alerts, anomaly detection, and in-depth analytics.

The embodiments provide AaC standards, integrate infrastructure with application code, provide modular and extensible components, and utilize AI and automation. By way of example, AaC standards define a comprehensive set of standards and best practices for architecture metadata. This includes templates for common configurations and guidelines for custom architecture definitions. A metadata schema is developed that includes information about services, dependencies, resource requirements, and deployment configurations. This schema is flexible enough to accommodate both monolithic and microservices architectures.

DSL is used to define infrastructure in a way that integrates seamlessly with application code. These definitions are stored within the same code repositories as the application code to ensure cohesion. Libraries are created that developers can use to define and manage infrastructure within their application code. These libraries should abstract the complexities of infrastructure management, allowing developers to focus on application logic while ensuring that infrastructure requirements are met.

Infrastructure components are designed as modular units that can be easily composed into larger architectures. Each module should be independent and reusable, allowing for flexibility in architecture design. Dynamic configuration management tools are used to adapt to different environments and workloads. These tools should be able to adjust configurations on the fly based on real-time metrics and predefined policies.

AI-driven optimization algorithms are implemented that continuously analyze resource usage and performance metrics to optimize infrastructure configurations. This ensures efficient use of resources and reduces costs. Self-healing mechanisms are developed that automatically detect and resolve issues. These mechanisms are able to rollback changes, restart services, or provision additional resources as needed to maintain system stability.

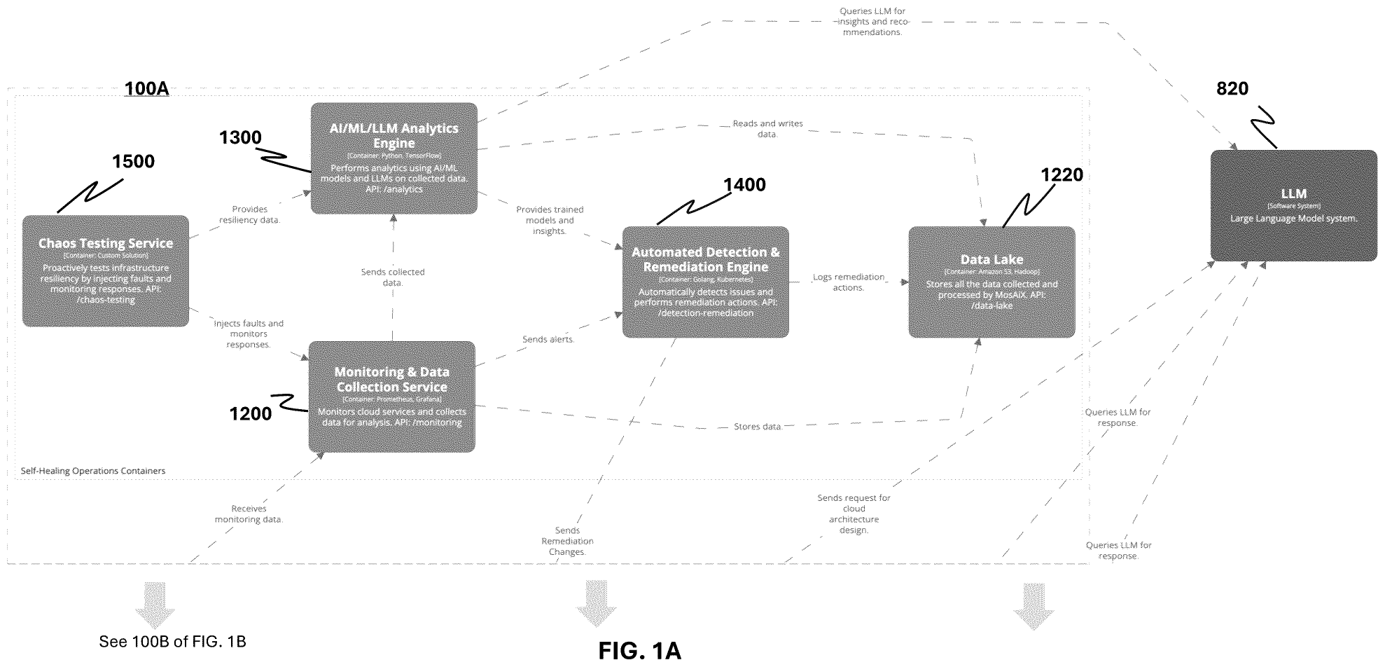

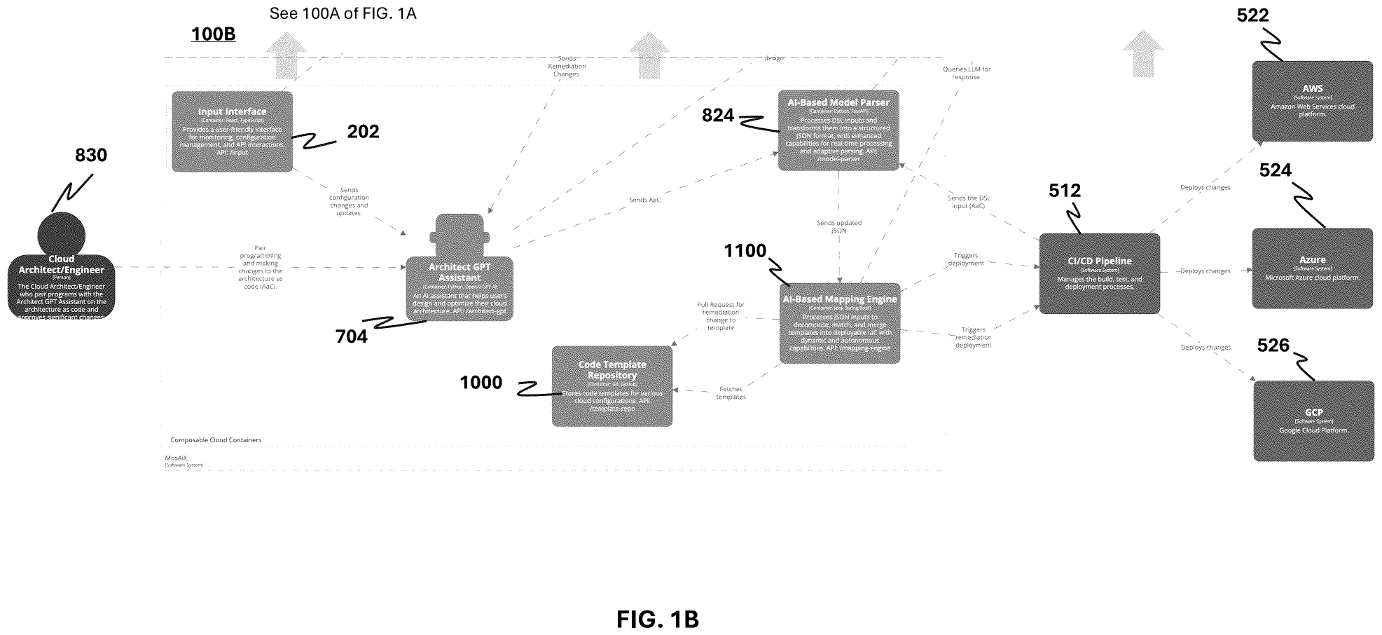

FIG. 1A illustrates part 1 of an exemplary high-level architecture block diagram of a composable multi-cloud management platform (also referenced herein as platform or Platform) 100A, including key components in accordance with one or more embodiments of the present disclosure. FIG. 1B illustrates part 2 of the high-level architecture block diagram of FIG. 1A. FIGS. 1A and 1B provide an overview of the entire system and how the key components interact. More specifically, FIGS. 1A and 1B illustrate the main components, such as the composable cloud, self-healing operations, APIs, and data flow between the components.

The exemplary multi-cloud management platform 100A/100B has a comprehensive suite of capabilities designed to manage, monitor, and optimize cloud environments autonomously. The platform 100A/100B, among other components, includes an input interface, an AGPT assistant, a model parser process, a code template repository, a mapping engine, a monitoring service application, an AI/ML/LLM analytics engine, an automated detection and remediation engine, and a chaos testing service module.

The input interface includes a user-friendly user interface (UI) built with React™ and an API handling via FastAPI™ for configuration management and interaction capability. A real-time monitoring dashboard is provided that uses a multi-platform open-source analytics and interactive visualization web application, such as Grafana™. The input interface also includes configuration management capabilities.

The AGPT assistant includes AI-driven architecture design and optimization that uses, for example, GPT-4. It also includes custom algorithms for generating cloud architectures and session management to preserve user interactions. The model parser process includes DSL processing and conversion to JSON along with advanced natural language processing (NLP) and ML for metadata extraction, and real-time data ingestion with stream-processing platforms, such as Kafka™ and Apache Flink™. A built-in feedback loop provides integration for continuous improvement.

The code and template repository enables storing and version control of development files using version control systems such as Git™. Oftentimes, many changes to code may be made by multiple users. As such it is important to manage (e.g., track changes across multiple updates) for code versions, merging changes together, etc. Template review and automated code review may be facilitated via GitHub™ repository actions. Deployments are tracked with AI-based analytics.

The mapping engine includes JSON decomposition and dynamic template matching, autonomous pattern generation and self-healing capabilities. Integration with LLMs is provided for enhanced processing. The monitoring service application provides real-time data collection with open-source monitoring and alerting toolkits such as Prometheus™. Predictive alerts and data visualization moderating are provided via web applications such as Grafana™. The monitoring service application also includes AI-driven anomaly detection and proactive issue detection.

The AI/ML/LLM analytics engine, depicted in FIG. 1A, performs in-depth data analytics using ML and AI software libraries such as TensorFlow™. The AI/ML/LLM analytics engine also performs predictive analysis and anomaly detection and provides training remediation models and leverages LLM for insights.

Automated Detection & Remediation Engine 1400 may detect issues and perform remediation actions using for instance, open-source programming languages such as Golang™. Open-source systems, such as Kubernetes™ may also be used to help manage and deploy containerized applications at scale. The automated detection and remediation engine includes a self-healing module for autonomous corrections. It also provides logging and tracking issues for continuous improvement. The chaos testing service module provides fault injection to test system resilience along with AI-driven resiliency analysis to identify weaknesses.

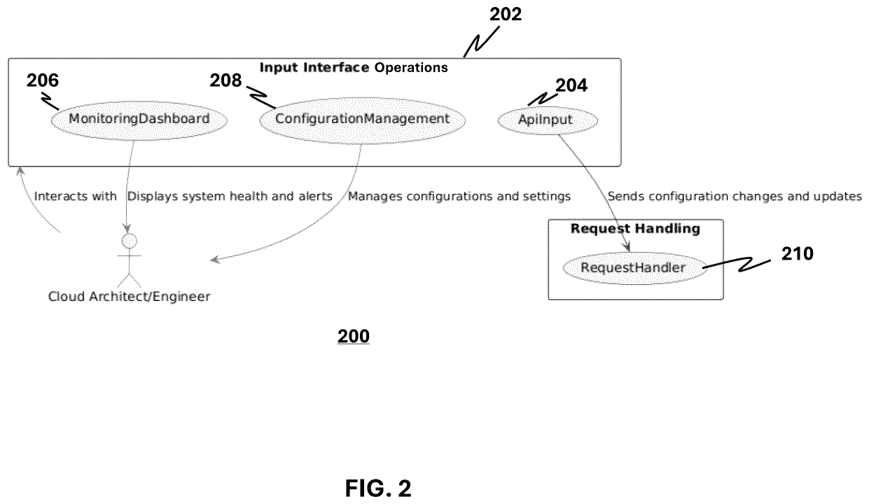

FIG. 2 illustrates an exemplary process model 200 in accordance with the embodiments. The process model 200 is configured to describe the processes and workflows within the multi-cloud management platform 100A/100B depicted in FIGS. 1A and 1B. Process model 200 includes diagrams for workflow processes such as configuration management, deployment pipeline, and AI-based optimization.

Process model 200 includes an input interface 202 to facilitate user interaction. That is, a user interacts with input interface 202 to monitor, configure, and manage cloud architecture. In the example process model 200, API requests for user interactions may be handled via ApiInput 204. ApiInput 204 also provides a monitoring dashboard, MonitoringDashboard 206, which monitors and displays system health, performance metrics, and alerts. A configuration management application, ConfigurationManagement 208, manages system configurations, settings, and access controls.

Process model 200 includes a request handling application, RequestHandler 210, which receives configuration changes from the ApiInput. Updates from Apilnput 204 are sent to RequestHandler 210. RequestHandler 210 processes incoming requests and interacts with other components with the platform (FIGS. 1A, 1B, and 2) as needed.

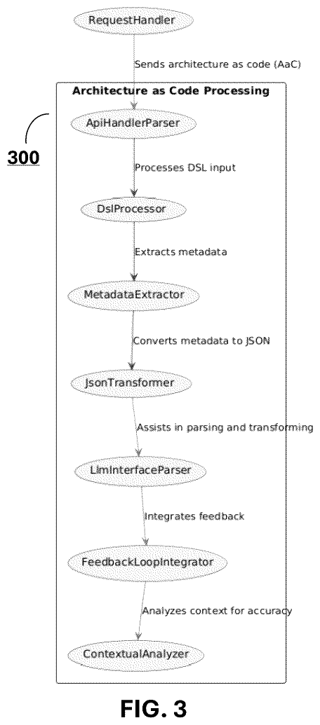

FIG. 3 illustrates AaC processing pipeline 300 in accordance with the embodiments. In FIG. 3, as depicted in FIG. 3, the RequestHandler of FIG. 2 sends the AaC to an ApiHandlerParser within AaC processing pipeline 300 to initiate pipeline processing. A DslProcessor processes a DSL input to extract defined elements and their metadata. A MetadataExtractor extracts metadata from DSL for further processing. A JsonTransformer converts the processed DSL and metadata into a structured JSON format. An LlmInterfaceParser assists in parsing and transforming DSL to JSON. A FeedbackLoopIntegrator, within the AaC pipeline 300, integrates feedback from deployment outcomes. A ContextualAnalyzer analyzes context from historical data to improve parsing accuracy.

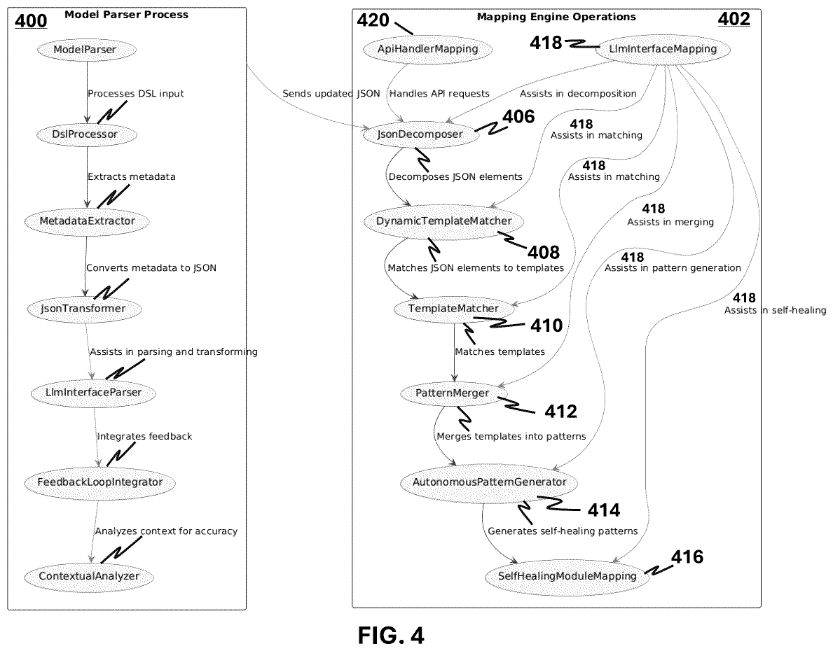

FIG. 4 illustrates a more detailed view, of operations of Model Parser Process 400 and Mapping Engine 402, as compared with that shown in FIGS. 1A/1B. In FIG. 4, Model Parser process 400 sends updated human readable code, such as JSON, to Mapping Engine 402. Mapping Engine 402 processes structured code inputs, such as JSON inputs, to decompose, match, and merge templates into deployable IaC. While JSON conversion would not be necessary to accomplish in the case where AI would be used without human supervision, AI-generated hallucinations might otherwise go unchecked without human supervision such as that offered by Cloud Architect/Engineer 830 (who pairs programs with Architect GPT Assistant 704 on the AaC and approves significant changes), shown in FIG. 1B. For instance, in some embodiments, AaC may be transformed into JSON, prior to converting it into templates for use as IaC, to permit human review and approval before making certain system changes. The transformation to a human-readable format (such as is the case with JSON) is necessary as it facilitates human review. JsonDecomposer 406 decomposes JSON into individual elements and DynamicTemplateMatcher 408 dynamically matches JSON elements to templates using real-time data. TemplateMatcher 410 matches decomposed elements to appropriate IaC templates from a repository (not shown). PatternMerger 412 merges multiple IaC templates into a cohesive deployment pattern and in response, AutonomousPatternGenerator 414 generates new IaC patterns autonomously based on identified issues. SelfHealingModuleMapping 416 may implement self-healing mechanisms to automatically correct deployment issues, such as misconfigurations or errors introduced through overridden variables, reused modules or environmental-specific changes. These issues can lead to the following: discrepancies between IaC templates and actual deployments; incorrect code version deployment; and network issues, among others.

LimInterfaceMapping 418 may assist in decomposition, matching, and merging processes as indicated by the arrowed paths emanating from LimInterface Mapping 418. ApiHandlerMapping application 420, in conjunction with the Mapping Engine Operations 402, may handle API requests and responses.

FIG. 4 also shows process steps occurring at various applications as indicated. For instance, DSL input is processed at an application, DSIProcssor. Metadata is extracted at a metadata extractor application and metadata is converted to JSON at a JsonTransformer application. The assistance in Parsing and transforming JSON occurs at the LimInterface Parser application. Feedback is integrated at the FeedbackLoopintegrator application and content is analyzed for accuracy at the Contextual Analyzer application. The various foregoing applications are named according to various functions that may represent processes carried out by code running on one or more processors.

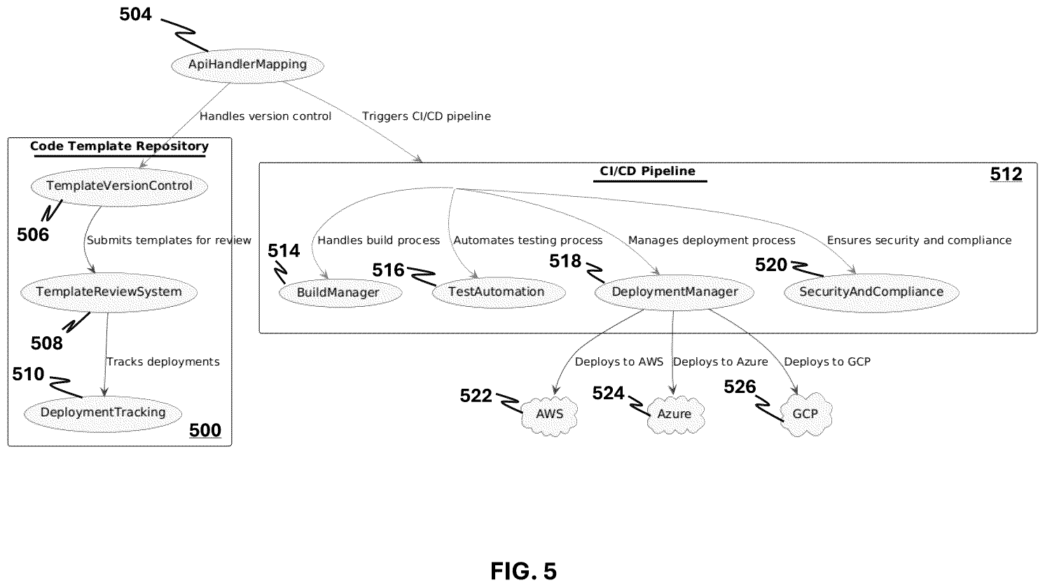

FIG. 5 illustrates a workflow pursuant to an exemplary interaction, at Code Template Repository 500, based upon the ApiHandlerMapping application noted in Mapping Engine Operations 402 of FIG. 4. Code templates, such as cloud infrastructure templates, are pre-defined code configurations that automate and manage cloud resources. Code templates may serve to quickly deploy and manage infrastructure changes on a consistent basis given, that by nature, they reduce manual efforts and as a consequence thereof, errors. Templates may serve to automate the creation and configuration of cloud resources, such as virtual machines, networks and storage.

In FIG. 5, ApiHandlerMapping 504 may interact with Code Template Repository 500 to effect template version control, review, and tracking. TemplateVersionControl 506 may manage version control and tracking of templates and TemplateReviewSystem 508 may handle review and approval of updated templates before merging. DeploymentTracking 510 may track deployments of template versions across an organization.

A deployment process for implementing enterprise network changes may be implemented as part of the ApiHandlerMapping application. The ApiHandlerMapping application may trigger the deployment process via CI/CD Pipeline 512. BuildManager 514 handles the build process. A TestAutomation application 516 automates the testing process. An application, SecurityAndCompliance 520, manages security and compliance of IaC. DeploymentManager 518, an application, manages the deployment process and deploys changes to various cloud platforms (e.g., AWS 522, Azure 524, GCP 526, etc.).

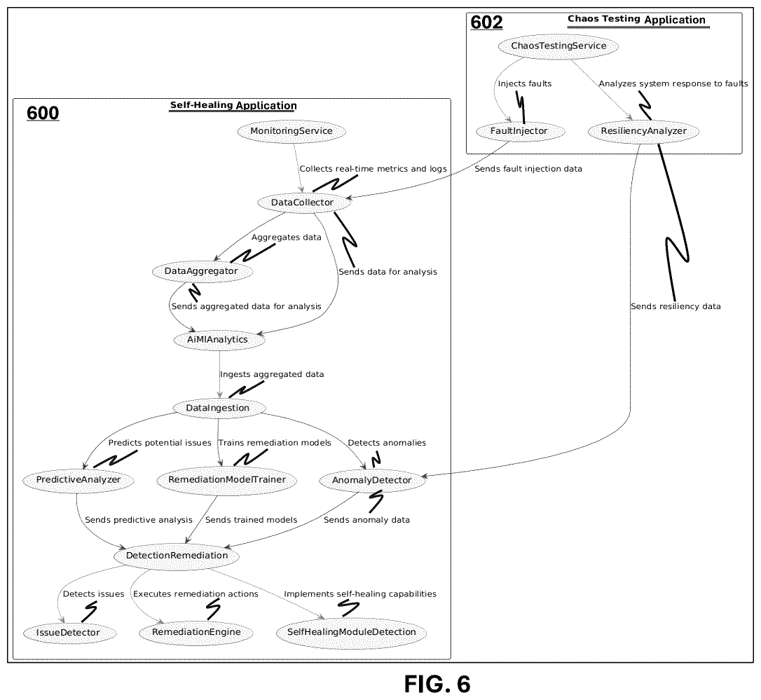

The Platform, as disclosed herein may exhibit a self-healing network. A self-healing network is a network that may automatically detect, diagnose and resolve network issues using AI and ML with minimal or no human intervention. FIG. 6 illustrates an exemplary self-healing application 600 and a chaos testing application 602 in accordance with the embodiments. Chaos testing is a method of deliberately introducing controlled failures and disruptions into a network for the purpose of identifying weaknesses and assessing network resilience to disruptions.

Self-healing application 600 includes a MonitoringService application that monitors cloud services and collects data for analysis. A DataCollector application gathers real-time metrics and logs. An AlertManager application manages alerts based on predefined thresholds and conditions. A DataAggregator application aggregates collected data for analysis. AiMlAnalytics application performs analytics using AI/ML models and LLMs on collected data. A DataIngestion application ingests aggregated data. An AnomalyDetector application detects anomalies and deviations from normal behavior. A PredictiveAnalyzer application predicts potential failures and performance issues.

Within self-healing application 600, a RemediationModelTrainer application trains remediation models. A LlmInterfaceAnalytics application uses large language models to provide insights and recommendations. A DetectionRemediation engine automatically detects issues and performs remediation actions. An IssueDetector application detects issues based on analytics and alerts. A RemediationEngine application executes remediation actions. A SelfHealingModuleDetection application implements self-healing capabilities.

Chaos Testing Application 602 includes ChaosTestingService application that proactively tests infrastructure resiliency by injecting faults and monitoring responses. The ChaosTestingService application includes a FaultInjector application that injects various types of faults into the system. A ResiliencyAnalyzer application analyzes system responses to injected faults and identifies weaknesses. The various foregoing applications are named according to various functions that may represent processes carried out by code running on one or more processors.

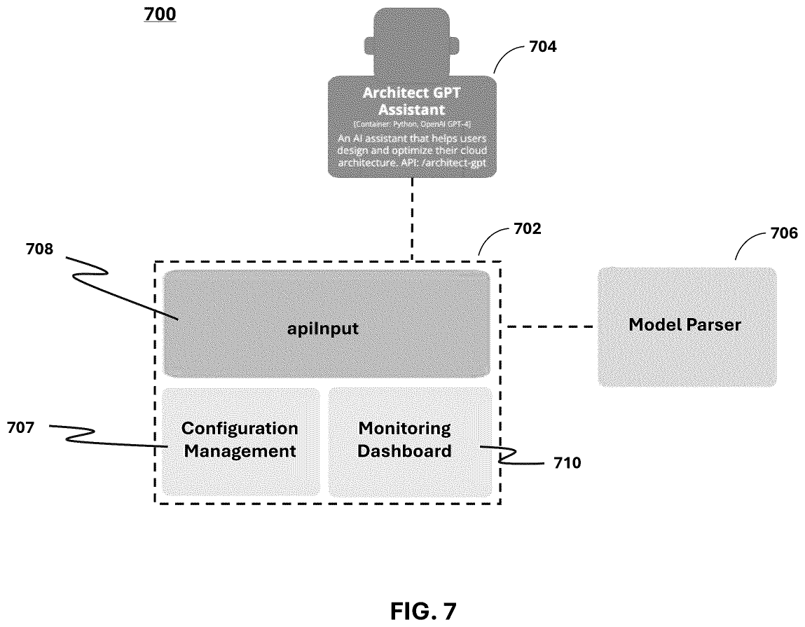

FIG. 7 represents a component interaction diagram, specifically exemplary of system 700, that shows how individual components within each main domain within the multi-cloud management platform 100A/100B interact with one another. For example, system 700 includes UI 702, AGPT assistant 704, and Model Parser 706, which are components within system 700 of multi-cloud management platform 100A/100B.

In system 700, for example, UI 702 is designed to provide an interactive interface for monitoring, configuration management, and API interactions. While multi-cloud management platform 100A/100B is modular, input interface 700 serves as the entry point for users to interact with the multi-cloud management platform 100A/100B, allowing users to manage and monitor their cloud environments.

UI 702 may include several components, each of which may be responsible for specific functionalities. For example, UI 702 may be configured for displaying dashboards, status, and alerts. UI 702 may also provide forms and inputs for configuration management 707 for users to employ with the multi-cloud management platform. Configuration management 707 may represent an application for maintaining an IT system. UI 702 may be a graphical user interface. In some embodiments, UI 702 may be based upon the React™ JavaScript™ library, although other technologies are within the spirit and scope of the present disclosure. React™ is an Open Source JavaScript library for building user interfaces.

UI 702 may also include an API input, apilnput 708. ApiiInput 708 is a component configured for handling user API requests and validating and processing input data. ApiInput 708 forwards requests to backend services and returns responses to UI 702. In some embodiments, apiInput 708 handles API requests for user interactions, acting as middleware, processing requests from UI 702 and forwarding the requests to the appropriate backend services. In the embodiments, UI 702, may be based upon a web framework, such as Python's FastAPI although other technologies are within the spirit and scope of the present disclosure. FastAPI is a web framework for building APIs with Python based on standard Python type hints. Type hints are annotations for declaring a type of variable.

Monitoring Dashboard 710 may be provided for visualizing real-time data and metrics. Monitoring Dashboard 710 may display alerts and notifications and provide detailed reports and analytics on system performance. Monitoring Dashboard 710 may also display system health, performance metrics, and alerts and provide real-time insights into the state of the cloud environment. In one exemplary embodiment, Monitoring Dashboard 710 is based on React™ and Grafana™ technologies.

Configuration management 707 manages and stores configuration settings and access controls in an effort to ensure that configurations are applied consistently across the Platform. Configuration management 707 provides interfaces for users to modify and update configurations. In some embodiments, Configuration Management 707 is based on React™ and FastAPI™ technologies.

The input interface 702 relates to and interacts with various other components and services within the multi-cloud management platform 100A/100B to facilitate a seamless user experience. For example, an apiInput interaction may include the following Python™ code:
1. apiInput->requestHandler “Sends configuration changes and updates.”
2. apiInput->dataCollector “Receives monitoring data.”
3. apiInput->sessionManager “Manages user access and permissions.”

The apiInput component forwards requests to a backend service, such as a request handler. AGPT assistant 704 may help in handling responses. Monitoring dashboard 710 may receive data from the dataCollector component to display real-time metrics and alerts. Relationship: monitoringDashboard->dataCollector “Receives monitoring data.”

Configuration Management component interacts with the apiInput component to handle configuration changes and updates. Relationship: configurationManagement->apiInput “Sends configuration updates.”

Input interface 702 includes a functional workflow. Within this workflow, for example, users interact with a UI component to perform various tasks, such as viewing system status, configuring settings, and monitoring performance. A component, apiInput 708 processes user requests, validates the input data, and forwards the requests to the appropriate backend services. It also handles responses from the backend and sends them back to the UI (not specifically shown) for display. Monitoring Dashboard 710 continuously receives real-time data from a dataCollector component (FIG. 6).

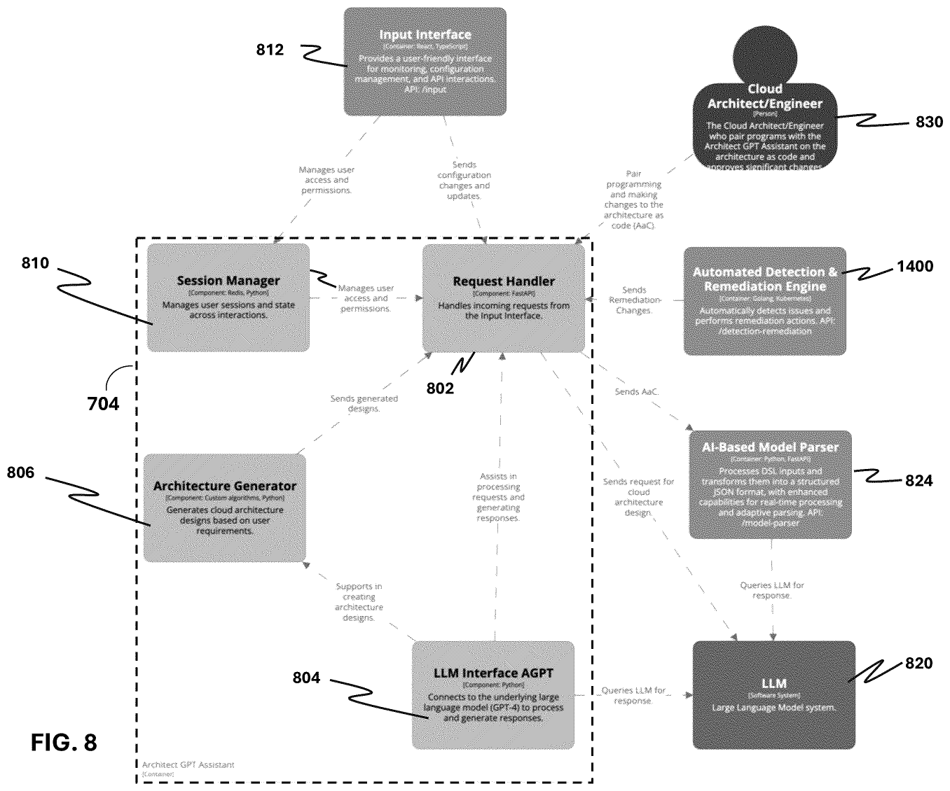

FIG. 8 illustrates both a detailed view of AGPT Assistant 704 depicted in FIG. 7, and an attendant workflow in accordance with embodiments described herein. AGPT Assistant 704, may be a component of the multi-cloud management platform 100A/100B, for aiding users in designing and optimizing cloud architecture. AGPT Assistant 704 may use AI and natural language processing capabilities, using a large language model such as GPT-4, to provide AI assistance throughout an architecture design process.

AGPT Assistant 704 may include several specialized components, each with distinct functionalities that work together to deliver architectural support. For instance, AGPT Assistant 704 may include Request Handler 802, LLM interface AGPT 804, architecture generator 806, and session manager 810.

Request Handler 802 may be configured for receiving and processing incoming requests, routing requests to relevant components. Request Handler 802 may use natural language processing (NLP), for understanding and categorizing incoming requests. Request Handler 802 is the initial point of contact for incoming requests from Input Interface 812. Request Handler 802 routes requests to the appropriate components/applications in conjunction with AGPT Assistant 704. In one exemplary embodiment, Request Handler 802 uses FastAPI™ technology to provide AI Enhancements.

LLM interface AGPT 804 is provided for interfacing with a large language model for processing requests and generating responses based on user queries. LLM interface AGPT 804 may therefore provide AI-generated suggestions and solutions. In some embodiments, LLM interface AGPT 804 uses GPT-4 in connection with processing requests and generating responses. One exemplary embodiment is based on Python™ technology. Embodiments of the present disclosure, however, are not limited to Python™. Other language, including script-based languages may be used in connection with the present disclosure.

Architecture Generator 806 is configured for generating architecture designs based on input requirements and ensuring designs are optimized for performance, cost, and scalability. Architecture Generator 806 may also provide architectural diagrams and documentation. In some embodiments, Architecture Generator 806 may use ML and AI algorithms to generate designs and create cloud architecture designs based on user requirements. Architecture Generator 806 may also use custom algorithms. Exemplary embodiments of the disclosure may be created using custom algorithms written in the Python™, which is a general-purpose programming language.

Session Manager 810 may be provided for managing user sessions, maintaining state, storing session data, and ensuring that session data is retrievable. Session Manager 810 may also handle user authentication and access control. Session Manager 810 may use algorithms for session management and state preservation. Session Manager 810 may handle user sessions and maintain state across interactions. Session Manager 810 may also ensure that a user's progress and data are preserved throughout an interaction with Architect AGPT 704. Exemplary embodiments are developed using Redis™ and Python™ technologies. Redis™ is an Open Source in-memory data structure store that is often used as a database cache, message broker and streaming engine.

Architect GPT Assistant 704 may interact with various components and services within the multi-cloud management platform 100A/100B to provide architectural assistance and design capabilities. Within the Architect GPT Assistant 704, request handler 802 Python-based interactions may include the following:
1. requestHandler->apiHandlerParser “Sends AaC.”
2 requestHandler->apiHandlerParser “Sends Remediation Changes.”
3. requestHandler->IlmInterfaceAGPT “Routes requests for processing.”
4. requestHandler->architectureGenerator “Sends generated designs.”

### Relationships:

Python-based interaction with LLM Interface AGPT 804 may include:
1. llmInterfaceAGPT->requestHandler “Assists in processing requests and generating responses.”
2. llmInterfaceAGPT->architectureGenerator “Supports in creating architecture designs.”
3. IlmInterfaceAGPT->architectLLM “Queries LLM for response.”

Python-based Architecture Generator 806 interactions may include the following: architectureGenerator->requestHandler “Sends generated designs.” The session manager interactions include sessionManager->requestHandler “Manages user access and permissions.”

With respect to the workflow illustrated in FIG. 8, Request Handler 802 receives incoming requests from Input Interface 812. Request Handler 802 processes these requests and routes the request to large language model (LLM) 820. LLM 820 may represent GPT-4. LLM 820 process requests and generates responses in an effort to provide accurate and relevant suggestions. Request Handler 802 also sends AaC to AI-based Model Parser 824 which processes DSL inputs and transforms those DSL inputs into a structured JSON format. AI-Based Model Parser 824 may provide real-time processing and adaptive parsing.

Adaptive parsing refers to a parsing methodology that can adjust or learn from the input data or the environment to improve parsing accuracy and/or efficiency among other things. AI-based Model Parser 824 may also query LLM 820 pursuant to AI-based Model Parser 824's parsing activities. Automated Detection & Remediation Engine 1400 may detect issues and perform remediation actions, sending changes to request handler 802 for proper disposition (e.g., to send requests for cloud architecture design to LLM 820, send Aac to AI-based Model Parser 824, etc.).

Architecture Generator 806 may use custom algorithms and AI to create cloud architecture designs based on user requirements. Architecture Generator 806 may also attempt to ensure that the designs are optimized for various factors such as performance, cost, and scalability. Session manager 810 may handle user sessions, maintaining state across interactions. Session manager 810 manages session data, user authentication, and access control, preserving users' progress and data throughout their interactions.

Cloud Architect/Engineer 830 may be a corporeal entity that pairs programs with Architect GPT Assistant 704 concerning AaC. Cloud Architect/Engineer 830 may also serve to approve AaC changes on the Platform.

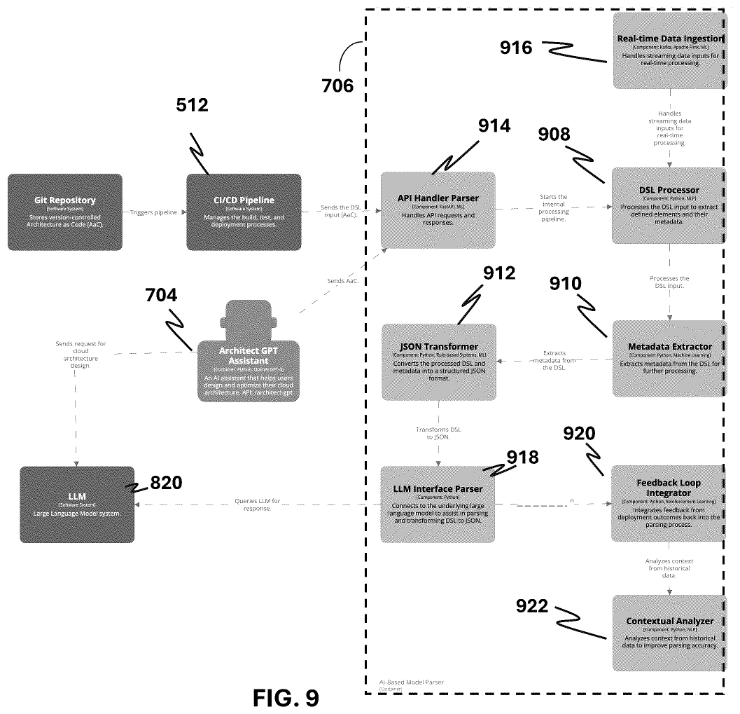

FIG. 9 illustrates both a block diagram and a process flow of and involving model parser 706, depicted in FIG. 7, in accordance with the embodiments. Given the dual nature of the drawings, the process flow illustrates the actions performed by the blocks from which the process arrows originate. Model parser 706 is a container in multi-cloud management platform 100A/100B (see FIGS. 1A and 1B), responsible for parsing DSL inputs (received, for instance, through CI/CD Pipeline 707) and transforming those inputs into a structured computer language of a different format such as JSON.

Model parser 706 may provide real-time processing, adaptive parsing, and contextual analysis of code. Real-time parsing of data references analyzes and extracts information from a continuous stream of data in connection with its arrival at an input as opposed to batch processing of that data. Contextual analysis of code can provide transformed structured code based on, for instance, deep learning processing provided LLM 820. Model parser 706 may parse and transform DSL into another code, such as JSON. Parsing, or syntax analysis, analyzes a string of symbols. Model parser 706 may include several specialized components, each tasked with distinct functionalities to ensure the accurate transformation of DSL inputs into outputs such as JSON outputs.

For instance, model parser 706 may include DSL processor 908, metadata extractor 910, JSON transformer 912 and API Handler Parser 914. DSL processor 908 processes DSL input received from Real-time Data Ingestion unit 916, and it identifies and extracts key elements from the DSL and attendant relationships thereof. Real-time Data Ingestion component 916 may intake streaming data, enabling real-time analysis, for instance, JSON transformation.

Metadata Extractor 910 extracts metadata from the DSL. An NLP model may be provided as part of DSL processor 908 to advance the accurate identification and extraction of DSL elements and relationships. DSL Processor 908 may receive DSL input from a real-time data ingestion component 916. In some embodiments, Processor 908 may extract predefined elements and associated metadata based upon Python language and NLP technologies.

Metadata extractor 910 parses metadata associated with each DSL element. The metadata may contain complex structures and be nested. Metadata extractor 910 may leverage ML models for efficient parsing and understanding of complex and nested metadata structures. In some embodiments, metadata extractor 910 may focus on extracting detailed metadata from the DSL based on Python.

JSON transformer 912 may transform processed data into JSON objects and ensure that the JSON format adheres to a predefined schema suitable for a mapping engine. JSON transformer 912 may also validate a JSON structure to ensure completeness and correctness. JSON transformer 912 may use rule-based systems and ML models for JSON transformation and validation. JSON transformer 912 converts processed DSL elements and metadata into a structured JSON format in accordance with for instance, Python™, Rule-based Systems, and ML technologies.

LLM interface parser 918 interfaces with an LLM model (not specifically shown) to enhance parsing accuracy by leveraging the LLM's ability to interpret complex language and context. LLM interface parser 918 connects to the underlying large language model (not specifically shown) to assist in parsing and transforming DSL to JSON in accordance with, for instance, Python™ general-purpose programming language principles.

API handler 914 manages API requests and responses, facilitating communication between the model parser 706 and other components using for instance FastAPI™ and ML technologies. API handler 914 may implement ML models for adaptive rate limiting, predictive error handling. and enhanced security.

Real-time data ingestion 916 may be implemented as an application for ingesting streaming data in real time and processing incoming data continuously to enable real-time analysis and transformation to, for instance, JSON. It uses ML models for optimizing real-time data ingestion and analysis, leveraging stream processing frameworks such as Apache Flink™, as one example. It handles streaming data inputs for real-time processing in accordance with Kafka™, Apache Flink™, and ML technologies.

As shown in FIG. 9, Model Parser 706 may include Feedback Loop Integrator 920 and Contextual Analyzer 922. Feedback loop integrator 920 may collect feedback from deployment outcomes, use feedback to refine and improve the parsing process, and implement reinforcement learning to adapt parsing logic based on real-world performance. Feedback Loop Integrator 920 may apply reinforcement learning (RL) for continuous improvement and adaptation of the parsing process based on deployment feedback. In an exemplary embodiment, feedback may be integrated from deployment outcomes back into the parsing process using Python and RL.

Contextual Analyzer 922 may provide an analysis of historical data by interpreting context and trends using NLP techniques to enhance parsing accuracy. Contextual Analyzer 922 may also apply contextual understanding to disambiguate and correctly interpret DSL elements using NLP for context understanding and trend analysis using historical data. In some embodiments, Contextual Analyzer 922 may analyze context from historical data to improve parsing accuracy using Python and NLP.

Model parser 706 may interact with various components and services within the multi-cloud management platform 100A/100B (FIGS. 1A and 1B). Interactions with DSL processor 908 may include (Python notation): dslProcessor->metadataExtractor “Processes the DSL input.” Metadata extractor interactions include relationship: metadataExtractor->json Transformer “Extracts metadata from the DSL.” JSON transformer interactions include relationship: jsonTransformer->IlmInterfaceParser “Transforms DSL to JSON.”

LLM interface parser interactions include:
1. IlmInterfaceParser->feedbackLoopIntegrator “Integrates feedback from deployment outcomes.”
2. IlmInterfaceParser->parserLLM “Queries LLM for response.”

API Handler Parser 912 interactions may include relationship: apiHandlerParser->dslProcessor “Starts the internal processing pipeline.” Real-time data ingestion interactions include: relationship: realTimeDataIngestion->dslProcessor “Handles streaming data inputs for real-time processing.” Feedback loop integrator interactions include relationship: feedbackLoopIntegrator->contextualAnalyzer “Analyzes context from historical data.”

The workflow shown in FIG. 9 illustrates that DSL processor 908 reads DSL input, identifies key elements and relationships, and extracts associated metadata. Metadata Extractor 910 parses the metadata, ensuring it is correctly formatted and complete for further processing. JSON transformer 912 converts the processed DSL elements and metadata into a structured JSON format, adhering to a predefined schema.

LLM Interface Parser 918 may use a large language model to enhance parsing accuracy and context understanding.

Feedback Loop Integrator 920 may collect feedback from deployment outcomes, using it to refine and improve the parsing process through reinforcement learning. Contextual Analyzer 922 may analyze historical data to improve parsing accuracy, leveraging NLP techniques for superior context understanding.

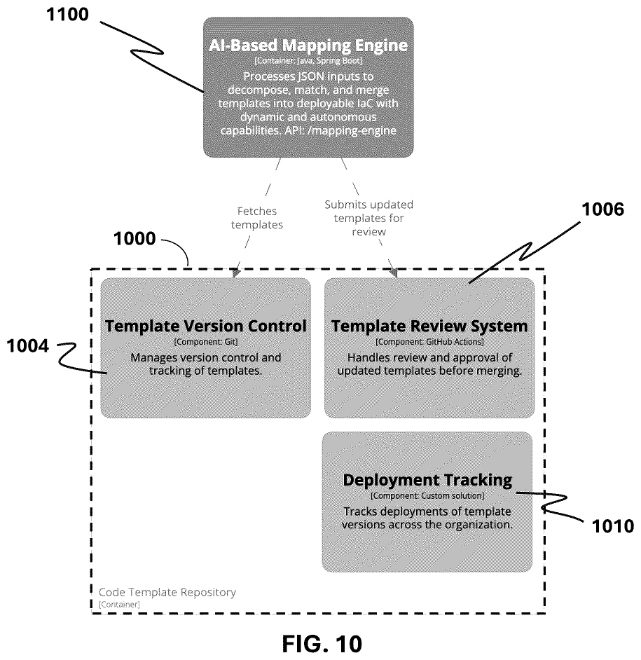

FIG. 10 illustrates a block diagram of Code Template Repository 1000 depicted in FIG. 1B of the multi-cloud management platform 100A/100B. Code template repository 1000 is a container and a component of Multi-Cloud Management Platform 100A/100B that manages the storage, version control, review, and deployment tracking of IaC templates. Code Template Repository 1000 ensures that all code templates are maintained, versioned, reviewed, and tracked properly to facilitate deployments across various cloud environments.

Code template repository 1000 may include several key components, each with distinct functionalities that contribute to the overall management and governance of IaC templates. In the exemplary embodiment of FIG. 10, Code Template Repository 1000 includes Template Version Control 1004, an application. Code Template Repository 1000 may also include Template Review System 1006, an application. Code Template Repository 1000 may additionally include another application, Deployment Tracking 1010.

Template Version Control 1004 is configured for managing version control for IaC templates, tracking changes, maintaining a history of revisions, and facilitating rollback to previous versions if necessary. Template Version Control 1004 may employ algorithms for version tracking and management. Template Version Control 1004 manages the version control and tracking of templates. Template Version Control 1004 ensures that each change to a template is versioned correctly and can be tracked back to its origin using, for example, Git version control.

Template Review System 1006 is configured for managing the review process for updated templates, ensuring that changes are approved before merging, and automated checks and validations. Template Review System 1006 may use AI for automated code review, identifying potential issues and suggesting improvements. Template Review System 1006 may also handle the review and approval of updated templates before they are merged into a main repository (not shown). This ensures that all changes are vetted and meet quality standards using, for example, GitHub™ (a proprietary developer platform) actions.

Deployment Tracking 1010 tracks deployments of IaC templates, monitors usage across different environments and teams, and provides notifications and alerts for new deployments. This application (Deployment Tracking 1010) may implement AI-based analytics to gain insights into deployment patterns and trends. Deployment Tracking 1010 may also track the deployments of template versions across an organization. Deployment Tracking 1010 may monitor where and how templates are being used, providing visibility into deployment activities using, for example, custom solutions.

Code Template Repository 1000 may interact with various components and services within multi-cloud management platform 100A/100B (FIGS. 1A and 1B) to facilitate the comprehensive management of IaC templates. Code Template Repository 1000 is a container that manages the storage, version control, review, and deployment tracking of IaC templates within multi-cloud platform 100A/100B. Code template repository 1000 is a vital part of the composable multi-cloud platform100A/100B, ensuring that IaC templates are managed, reviewed, and tracked efficiently.

By leveraging advanced AI techniques for version control, automated code review, and deployment analytics, this container (Code Template Repository 1000) provides robust governance and oversight of IaC templates. Code Template Repository 1000 (FIG. 1B) permits the seamless component interworking within multi-cloud platform100A/100B to maintain high standards of quality and compliance, facilitating smooth and efficient deployments across various cloud environments. This container (Code Template Repository 1000) ensures that all code templates are properly maintained, versioned, reviewed, and tracked, facilitating seamless deployments across various cloud environments, such as multi-cloud platform 100A/100B.

Example template version control interactions in Python include: apiHandlerMapping->template VersionControl “Fetches templates.” Template review system interactions are: apiHandlerMapping->templateReviewSystem “Submits updated templates for review;” and mappingEngine->codeTemplateRepo “Pull Request for remediation change to template.”

Further deployment tracking interactions may be ciCdPipeline->deploymentTracking “Tracks deployments of template versions.” A functional workflow is provided. Within workflows, templates may be versioned and tracked using GitHub™. Each change to a template may be recorded, ensuring a complete history of revisions. This enables users to understand the evolution of templates and revert to previous versions if necessary.

Template Review System 1004 may manage the review process for updated templates. When a template is updated, it goes through a review process where it is checked for quality and compliance. Automated checks and validations are performed using AI to identify potential issues and suggest improvements.

Deployment Tracking 1010 may monitor the deployment of IaC templates across the organization. Deployment Tracking 1010 may provide visibility into where and how templates are being used, ensuring that deployments are tracked and any issues are promptly addressed. AI-based analytics are used to gain insights into deployment patterns and trends, helping to optimize deployment processes.

Within a functional workflow example, a developer makes changes to an IaC template and commits the changes to the Git™ repository (a project managed with Git™, a distributed version control system). Template Version Control 1004 may track changes and update version history. A review process may include an updated template that is submitted for review through Template Review System 1006. Automated checks are performed, and AI-based suggestions for improvements are provided. Reviewers approve the changes, and the template is merged into the main repository.

A workflow involving Deployment Tracking 1001 may include an updated template that is deployed using a CI/CD pipeline (not shown). Deployment Tracking 1010 may monitor deployment, ensuring that a template is used correctly, and provide alerts for any issues. AI-based analytics may be used to analyze deployment patterns, providing insights into optimization opportunities.

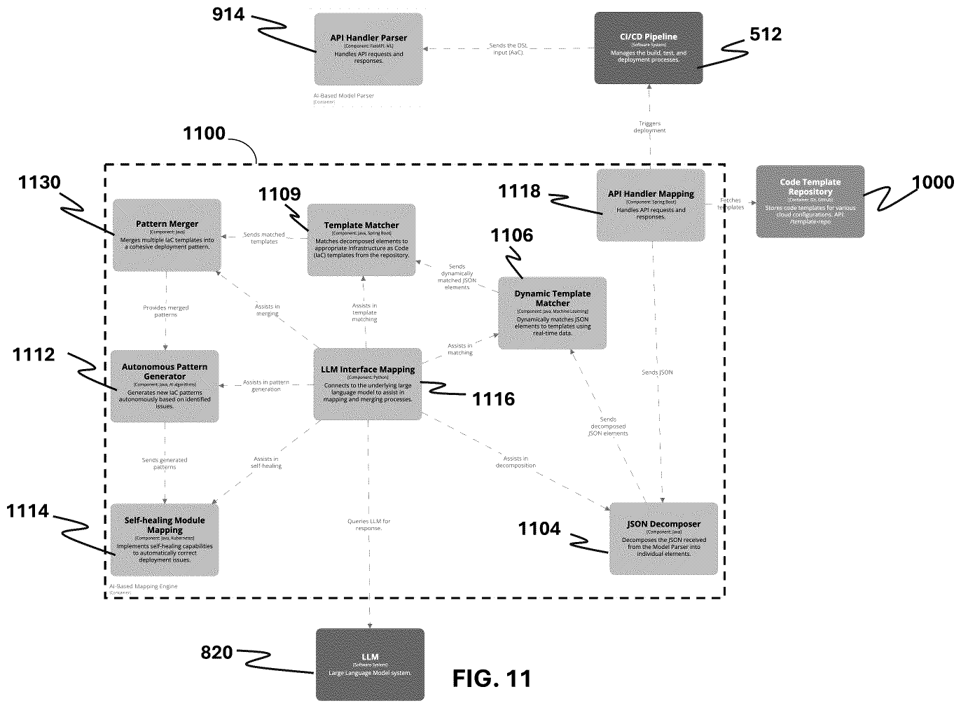

FIG. 11 illustrates a more detailed view of the AI-based mapping engine 1100, an application, depicted in FIGS. 1A/1B in accordance with the embodiments. Mapping Engine 1100 is a component of multi-cloud management platform 100A/100B (FIGS. 1A/1B) and it is responsible for processing inputs such as JSON inputs to decompose, match, and merge templates into deployable IaC. AI-based mapping engine 1100 may leverage AI capabilities, including ML and AI algorithms, to manage and deploy IaC.

By way of example only, and not limitation, within the AI-based mapping engine 1100, the decoupled patterns are created by cloud engineers. Determinations may be made by Cloud Architect/Engineer 830 (FIG. 1B) regarding the need for network, security, and load-balancing, storage, computer resources etc. Mapping Engine 1100 may receive preconfigured patterns and compile them into a monolithic.

AI-based mapping engine 1100 comprises several crucial components, each with specific functionalities that collectively enable the efficient processing and deployment of IaC templates. By way of example, the mapping engine 1100 includes a JSON Decomposer 1104, Dynamic Template Matcher 1106, and template matcher 1109. Also included are the following applications: Autonomous Pattern Generator 1112, Self-healing Module Mapping 1114, LLM interface mapping 1116, and API handler mapping 1118.

In exemplary embodiments, JSON Decomposer 1104 may provide parsing of inputs such as JSON inputs into manageable and actionable elements thereby providing decomposition for subsequent processing. JSON Decomposer 1104 uses ML models to improve the accuracy and efficiency of JSON decomposition. JSON Decomposer 1104 may decompose the JSON received from Model Parser 706 (FIG. 9) into individual elements using, for instance, Java™.

Dynamic Template Matcher 1106 may be configured for matching decomposed JSON elements to appropriate IaC templates. Dynamic Template Matcher 1106 may employ ML models for real-time analysis to enhance matching accuracy and dynamically match JSON elements to templates using real-time data using Java and ML.

Template Matcher 1109 maps each JSON element to a corresponding IaC template and validates template matches for accuracy. Template Matcher 1109 may use matching algorithms to improve template matching precision. The matching of decomposed elements to appropriate IaC templates from a repository may be accomplished in some embodiments using Java and/or Spring Boot technologies.

Pattern Merger 1130 is an application that may combine multiple matched templates into a single, deployable pattern in an effort to ensure that a merged pattern is cohesive and functional. Pattern Merger 1130 may also implement AI algorithms to optimize the merging process. Pattern Merger 1130 may merge multiple IaC templates into a cohesive deployment pattern using, for instance, Java.

Autonomous Pattern Generator 1112 may create new IaC patterns automatically in an effort to address deployment issues and enhance deployment efficiency and reliability through autonomous pattern generation. Autonomous Pattern Generator 1112 may use AI to autonomously generate and optimize new patterns and generate new IaC patterns autonomously based on identified issues using Java™ and AI algorithms.

Self-healing Module Mapping 1114 is an application configured for detecting and correcting deployment issues autonomously and ensuring deployments are resilient and self-healing. Self-healing Module Mapping 1114 may use AI to detect and resolve issues, ensuring deployment stability. Self-healing Module Mapping 1114 may implement self-healing capabilities to automatically correct deployment issues using, as an example, Java™ and Kubernetes™.

LLM Interface Mapping 1116 is integrated with an LLM to provide advanced language understanding and processing capabilities. LLM Interface Mapping 1116 connects to an underlying large language model to assist in mapping and merging processes using, for example, Python™.

API Handler Mapping 1118 manages API interactions for the mapping engine and ensures secure and efficient communication between components. API Handler Mapping 1118 utilizes ML models for adaptive rate limiting, predictive error handling, and enhanced security handling API requests and responses using frameworks like Spring Boot™.

Mapping Engine 1100 interacts with various components and services within the multi-cloud management platform 100A/100B to facilitate the comprehensive processing and deployment of IaC templates.

Internal Relationships within the mapping engine 1100 include:
1. jsonDecomposer->dynamicTemplateMatcher “Sends decomposed JSON elements”
2. dynamicTemplateMatcher->templateMatcher “Sends dynamically matched JSON elements”
3. templateMatcher->patternMerger “Sends matched templates”
4. patternMerger->autonomousPatternGenerator “Provides merged patterns”
5. autonomousPatternGenerator->selfHealingModuleMapping “Sends generated patterns”
6. llmInterfaceMapping->jsonDecomposer “Assists in decomposition”
7. llmInterfaceMapping->dynamicTemplateMatcher “Assists in matching”
8. llmInterfaceMapping->templateMatcher “Assists in template matching”
9. llmInterfaceMapping->patternMerger “Assists in merging”
10. llmInterfaceMapping->autonomousPatternGenerator “Assists in pattern generation”
11. llmInterfaceMapping->selfHealingModuleMapping “Assists in self-healing”

### External Relationships Involving Mapping Engine

1. apiHandlerMapping->jsonDecomposer “Sends JSON”
2. apiHandlerMapping->templateVersionControl “Fetches templates”
3. apiHandlerMapping->templateReviewSystem “Submits updated templates for review”
4. apiHandlerMapping->deploymentManager “Triggers deployment”
5. apiHandler Mapping->deploymentManager “Triggers remediation deployment”

Mapping Engine 1100 also includes exemplary workflows. For example, JSON Decomposer 1104 parses the JSON input from Model Parser 706 (FIG. 9) and breaks down JSON into individual elements. This ensures that each component of the JSON is isolated for specific processing.

Dynamic Template Matcher 1106 uses real-time data to accurately match the decomposed JSON elements to corresponding IaC templates. This process leverages ML models to improve matching accuracy. Dynamic Template Matcher 1106 validates and ensures that the JSON elements are matched to the correct templates. Dynamic Template Matcher 1106 may use advanced matching algorithms to enhance precision.

Pattern Merger 1130 combines multiple matched templates into a single, cohesive deployment pattern. Pattern Merger 1130 may also ensure that a merged pattern is functional and ready for deployment. Autonomous Pattern Generator 1112 creates new IaC patterns autonomously to address any identified deployment issues.

Self-healing Module Mapping 1114 detects and corrects deployment issues autonomously. This component ensures that deployments are resilient and capable of self-healing. LLM Interface Mapping 1116 uses a large language model to assist in various mapping and merging processes. This integration leverages LLM capabilities to improve processing accuracy. API Handler Mapping 1118 manages API requests and responses, facilitating communication between a Mapping Engine 1100 and other components.

Mapping Engine 1100 is a vital component of the multi-cloud management platform 100A/100B, ensuring the efficient processing and deployment of IaC templates. By leveraging advanced AI techniques, including ML, AI algorithms, and LLM integration, Mapping Engine 110 may provide dynamic and autonomous capabilities for managing IaC. The components within Mapping Engine 110 may work together to process JSON inputs, match them to appropriate templates, merge them into cohesive patterns, and deploy them.

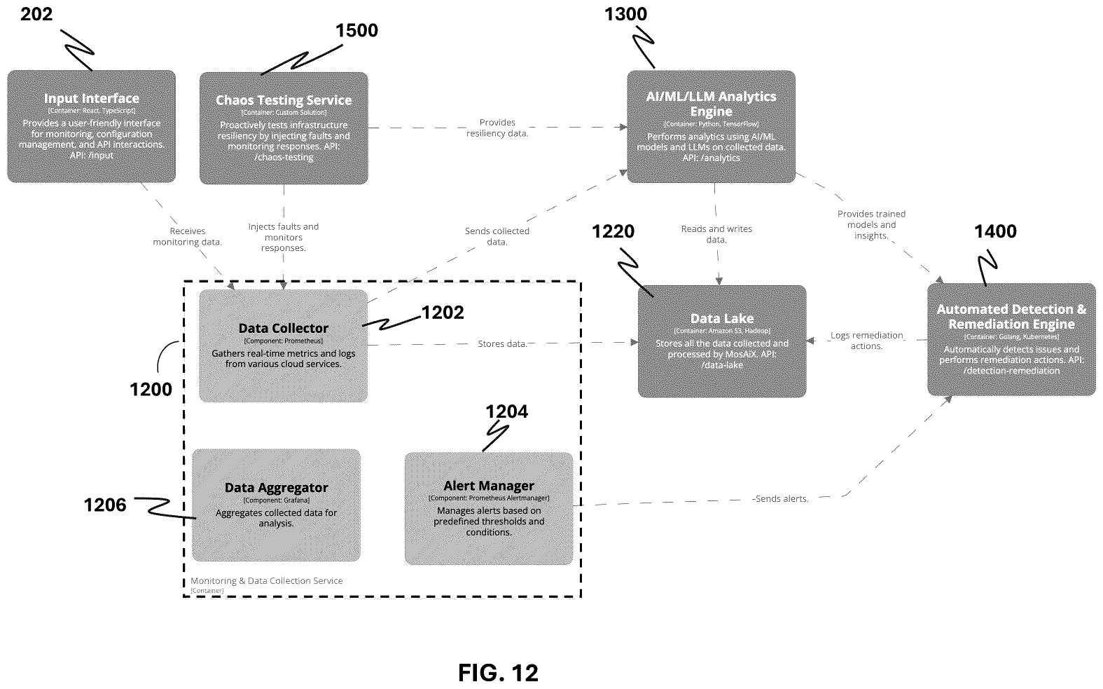

FIG. 12 illustrates both a block diagram and a process flow of a monitoring and Data Collection Service Application 1200. Data Collection Service Application 1200 may be responsible for monitoring cloud services, collecting real-time data, and providing the necessary analytics to ensure system health and performance

Monitoring and Data Collection Service Application 1200 may include several components, each being designed to perform specific functions that collectively ensure comprehensive monitoring and data collection. By way of example, Monitoring & Data Collection Service application 1200 may include data collector 1202, alert manager 1204, and data aggregator 1206.

Data Collector 1202 may be configured for collecting metrics, logs, and other performance data from cloud services. Data Collector 1202 may also ensure real-time data collection for immediate analysis using ML models to detect anomalies in the collected data. Data Collector 1202 may gather real-time metrics and logs from various cloud services using, for example, an open-source systems monitoring and alerting toolkit, such as Prometheus™.

Alert manager 1204 enables configuring and managing alert rules based on collected metrics and logs as well as sending notifications and alerts when predefined conditions are met. The alert manager implements AI to predict potential issues before they occur, allowing for proactive management and mitigation. It also manages alerts based on predefined thresholds and conditions using, for example, a marketing application such as Prometheus Alertmanager™.

Data Aggregator 1206 is configured to aggregate data from multiple sources for a unified view and preparing data for visualization and further analysis. Data Aggregator 1206 uses AI to enhance data visualization, making it easier to identify trends and patterns. It also aggregates collected data for analysis using, for example, Grafana™.

Monitoring and Data Collection Service Application 1200 interacts with various components and services within the multi-cloud management platform 100A/100B to provide comprehensive monitoring and data collection:

Internal relationships within the monitoring service include:
1. dataCollector->dataLake “Stores data.”
2. dataCollector->dataIngestion “Sends collected data.”
3. alertManager->issue Detector “Sends alerts.”

External relationships involving the monitoring service include:
1. apiInput->dataCollector “Receives monitoring data.”
2. faultInjector->dataCollector “Injects faults and monitors responses.”
3. resiliency Analyzer->anomalyDetector “Provides resiliency data.”

In one exemplary functional workflow of Monitoring and Data Collection Service Application 1200, according to an embodiment, Data Collector 1202 gathers real-time metrics, logs, and performance data from various cloud services. This ensures that all relevant data is collected promptly for immediate analysis and action. Alert Manager 1204 monitors the collected data against predefined thresholds and conditions. When conditions are met, alerts are generated and notifications are sent to relevant stakeholders for immediate attention and action.

Data Aggregator 1206 collects data from multiple sources and aggregates it into a unified format. This aggregated data is then prepared for visualization and further analysis, providing a comprehensive view of system performance and health. The collected data is continuously analyzed in real-time to detect anomalies and potential issues. ML models are employed to enhance anomaly detection, ensuring that any deviations from normal behavior are promptly identified.

AI models are used to predict potential issues before they occur. This proactive approach allows for the early detection and mitigation of issues, ensuring the reliability and stability of the cloud infrastructure. The collected and aggregated data is stored in a centralized data lake, Data Lake 1220. This data is then visualized using tools such as Grafana™, making it easier for stakeholders to understand system performance and identify trends and patterns.

Monitoring and Data Collection Service Application 1200 is a vital component of the multi-cloud management platform 100A/100B, providing comprehensive monitoring and data collection capabilities. By leveraging advanced AI techniques, including ML and predictive analytics, Monitoring and Data Collection Service Application 1200 ensures the reliability, availability, and performance of the cloud infrastructure. The components within this application work together seamlessly to collect real-time data, manage alerts, and provide comprehensive data aggregation and visualization. This application plays a critical role in maintaining the health and performance of the cloud infrastructure, enabling proactive issue detection and mitigation, and ensuring the overall stability of the multi-cloud management platform 100A/100B.

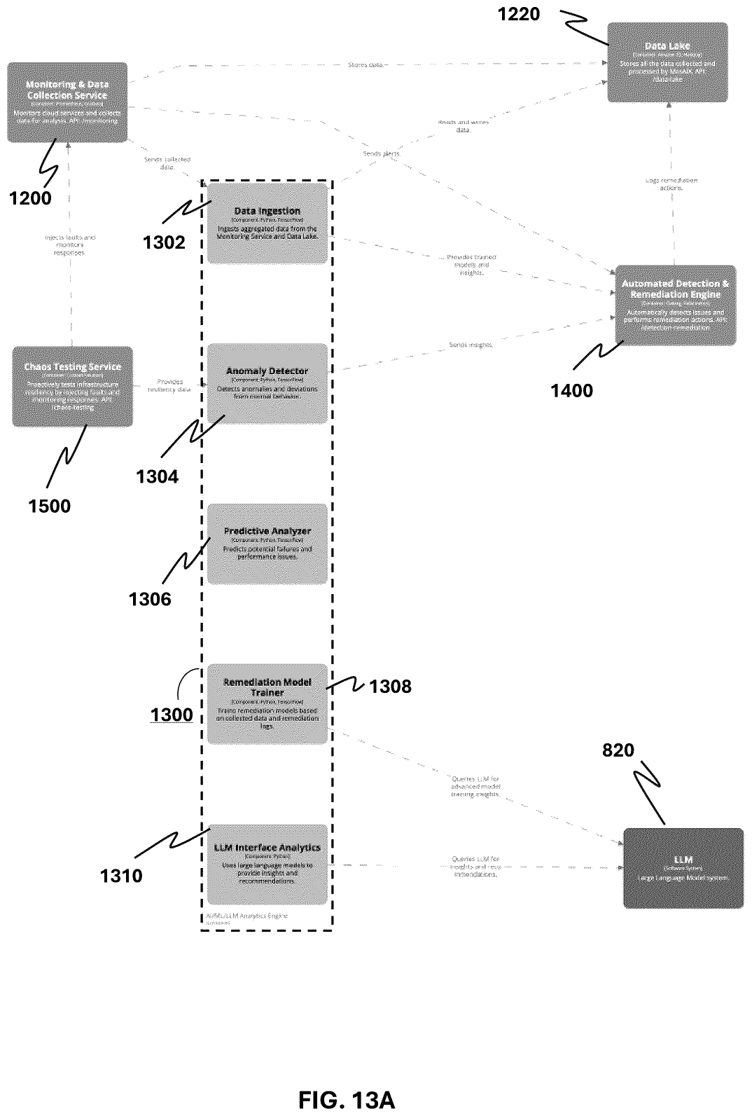

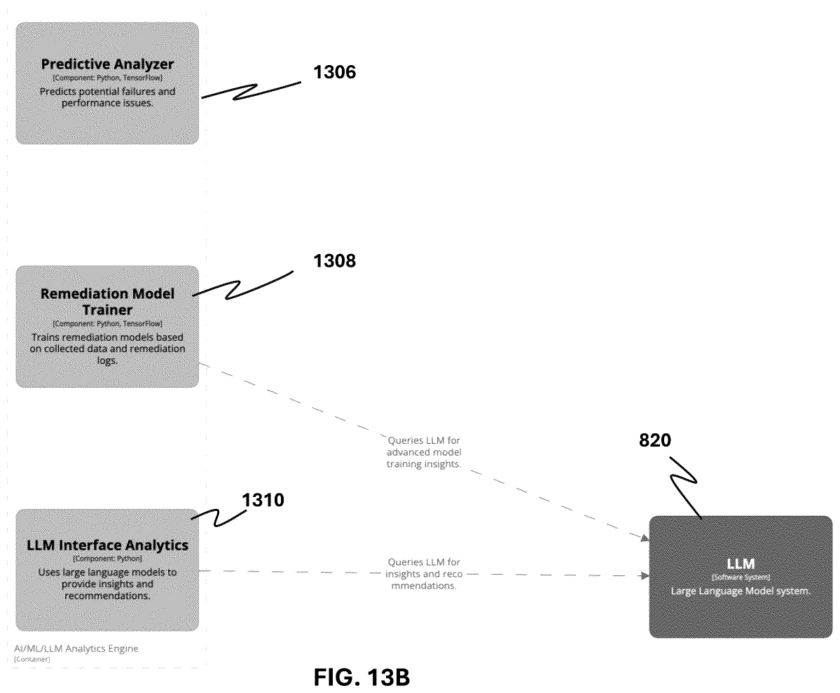

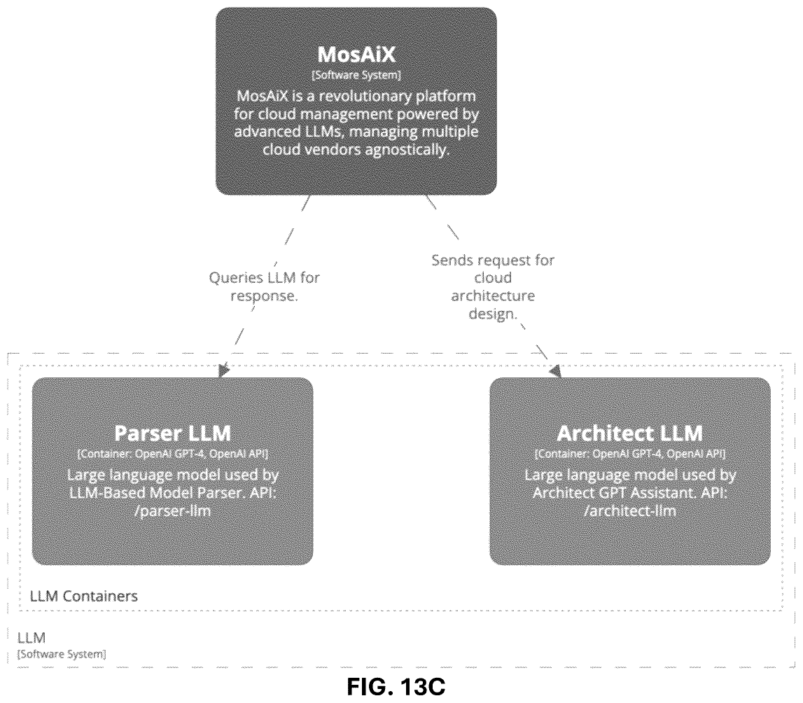

FIGS. 13A, 13B and 13C illustrate an exemplary AI/ML/LLM analytics engine 1300 according to the embodiments. The AI/ML/LLM analytics engine 1300 within the multi-cloud management platform 100A/100B (FIGS. 1A and 1B) is designed to leverage advanced AI, ML, and LLMs to perform in-depth analytics on collected data. Analytics Engine 1300 plays a crucial role in providing insights, detecting anomalies, predicting potential issues, and training remediation models to ensure the smooth and efficient operation of the cloud infrastructure. In the exemplary embodiment depicted in FIG. 13A, the AI/ML/LLM analytics Engine 1300 includes data ingestion application 1302, anomaly detector 1304, Predictive Analyzer 1306, Remediation Model Trainer 1308, and LLM Interface Analytics Application 1310.

The application, Data Ingestion 1302, facilitates continuously ingesting data from various sources for analysis and ensuring the data is properly formatted and prepared for further processing. Data Ingestion 1302 uses ML models to optimize data ingestion processes, ensuring high throughput and low latency. Data Ingestion 1302 ingests aggregated data from the Monitoring and Data Collection Service application 1200 and Data Lake 1220 based upon, for example, Python and TensorFlow concepts.

Anomaly Detector 1304 is configured for analyzing incoming data to identify unusual patterns or anomalies and flagging potential issues for further investigation. Anomaly Detector 1304 utilizes ML models to improve the accuracy and reliability of anomaly detection. It detects anomalies and deviations from normal behavior using, for example, Python™ and TensorFlow™.

Predictive Analyzer 1306 enables using historical data and ML models to predict future issues. It provides actionable insights to prevent potential failures and employees advanced predictive models to foresee potential problems and recommend preventive measures. Predictive Analyzer 1306 predicts potential failures and performance issues using, for example, Python™ and TensorFlow™.

Remediation Model Trainer 1308 provides training ML models using historical remediation data to continuously improve the models based on new data. It uses ML techniques to ensure remediation models are up-to-date and effective in resolving issues. Remediation Model Trainer 1308 enables training of remediation models based on collected data and remediation logs.

The application, LLM Interface Analytics 1310, is configured to query LLMs for advanced insights and contextual understanding. It enhances the analysis with NLP capabilities, leveraging LLMs, such as GPT-4, to provide deeper insights and recommendations based on complex data analysis. The LLM Interface Analytics 1310 uses LLMs to provide insights and recommendations based on, for example, Python concepts.

AI/ML/LLM Analytics Engine 1300 interacts with various components within the multi-cloud management platform 100A/100B and external services to perform its functions effectively. Internal relationships within AI/ML/LLM Analytics Engine 1300 include:
1. dataIngestion->dataLake “Reads and writes data.”
2. dataIngestion->issueDetector “Provides trained models and insights.”
3. anomalyDetector->issueDetector “Sends insights.”
4. llmInterfaceAnalytics->architectLLM “Queries LLM for insights and recommendations.”

External relationships involving the AI/ML/LLM analytics engine 1300 include:
1. dataCollector->dataIngestion “Sends collected data.”
2. resiliency Analyzer->anomalyDetector “Provides resiliency data.”

In a functional workflow, according to one exemplary embodiment, an application such as Data Ingestion 1302 continuously ingests data from the Monitoring & Data Collection Service Service 1200 and Data Lake 1220, ensuring that all relevant data is available for analysis. Anomaly Detector 1304 analyzes the ingested data to identify unusual patterns or anomalies. This component, Anomaly Detector 1304, uses ML models to enhance the accuracy of anomaly detection, ensuring that potential issues are promptly flagged for further investigation.

Predictive Analyzer 1306 uses historical data and ML models to predict potential failures and performance issues. This proactive approach allows for the early detection of potential problems, enabling preventive measures to be taken before issues escalate. Remediation Model Trainer 1308 trains ML models using historical remediation data. These models are continuously improved based on new data, ensuring they remain effective in resolving issues.

LLM Interface Analytics 1310 queries LLMs like GPT-4 to provide advanced insights and recommendations. This application may enhance analysis with natural language processing capabilities, enabling contextual understanding and decision-making.

AI/ML/LLM Analytics Engine 1300 is a vital component of the multi-cloud management platform 100A/100B, leveraging advanced AI, ML, and LLM techniques to provide comprehensive analytics and insights. Each component within the analytics engine 1300 plays a crucial role in ensuring the reliability, performance, and stability of the cloud infrastructure. By continuously ingesting data, detecting anomalies, predicting potential issues, training remediation models, and utilizing large language models for enhanced insights, the AI/ML/LLM Analytics Engine 1300 enables proactive management and optimization of the cloud environment. This application ensures that the multi-cloud management platform 100A/100B remains robust, adaptive, and capable of handling the complexities of modern cloud infrastructure management.

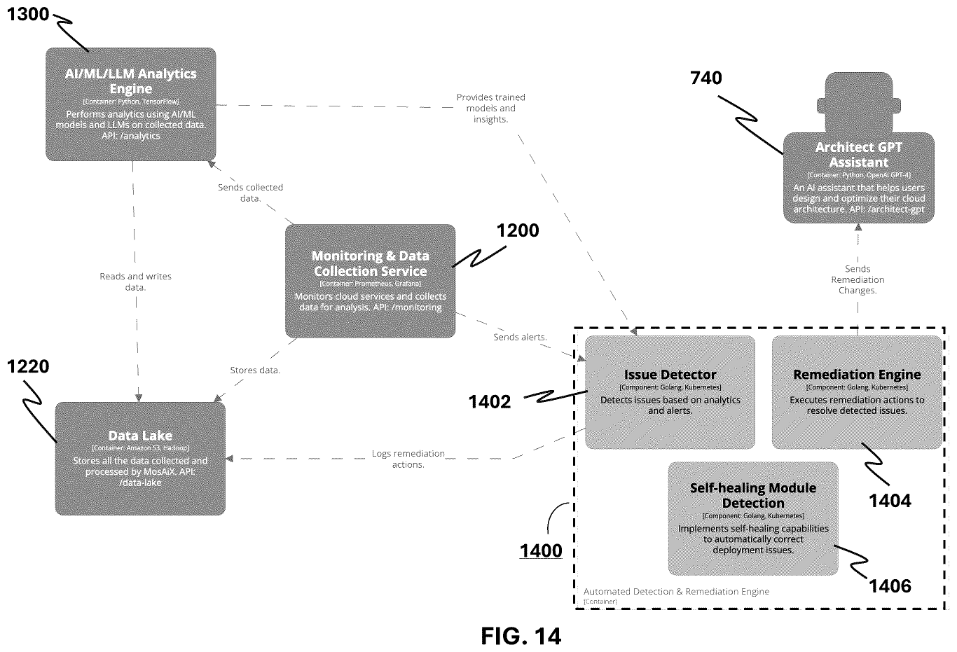

FIG. 14 illustrates an exemplary automated detection and remediation engine. Automated Detection and Remediation Engine 1400 within the multi-cloud management platform 100A/100B is designed to automatically detect issues and perform remediation actions to resolve the detected issues. This component is crucial for maintaining the stability, performance, and security of the cloud infrastructure by autonomously handling incidents and applying corrective measures.

Automated Detection and Remediation Engine 1400 includes several key components, each responsible for specific tasks related to issue detection and remediation. The exemplary Automated Detection and Remediation Engine 1400, depicted in FIG. 14, includes Issue Detector 1402, Remediation Engine 1404, and an application, Self-healing Module Detection 1406. Issue Detector 1402 is configured for analyzing data from various sources to detect issues and respond to alerts generated by other monitoring and analytics components. Issue Detector 1402 uses ML models to improve the accuracy and speed of issue detection. It detects issues based on analytics and alerts using, for example, Golang™, and Kubernetes™ technologies.

Remediation Engine 1404 enables the automatic application of predefined remediation actions to resolve detected issues and ensure that remediation actions are executed correctly and efficiently. Remediation Engine 1404 uses ML models to optimize remediation actions based on past performance and outcomes. It executes remediation actions to resolve detected issues.

The application, Self-healing Module Detection 1406, identifies deployment issues and applies self-healing measures to correct these issues. It provides for continuous monitoring of a system to ensure that it remains healthy and operational. Self-healing Module Detection 1406 uses AI algorithms to identify and apply the most effective self-healing actions and implements self-healing capabilities to automatically correct deployment issues.

Automated Detection and Remediation Engine 1400 interacts with various components within the multi-cloud management platform 100A/100B and external services to perform its functions effectively:

Internal relationships within the automated detection and remediation engine 1400 include:
1. issueDetector->remediationEngine “Sends issues for remediation.”
2. issueDetector->selfHealingModuleDetection “Sends detected issues for self-healing.”
3. remediationEngine->requestHandler “Sends Remediation Changes.”

External relationships involving the automated detection and remediation engine 1400 include:
1. alertManager->issueDetector “Sends alerts.”
2. anomalyDetector->issueDetector “Sends insights.”
3. dataIngestion->issueDetector “Provides trained models and insights.”
4. issueDetector->dataLake “Logs remediation actions.”

In a functional workflow, within an exemplary embodiment, Issue Detector 1402 continuously analyzes data from various sources, such as the monitoring service, the AI/ML/LLM analytics engine, and other monitoring tools, to identify potential issues. This component (Issue Detector 1402), of Automated Detection and Remediation Engine 1400, uses advanced detection algorithms to enhance the accuracy and speed of issue detection.

Issue Detector 1402 receives alerts and insights from anomaly detector and data ingestion components. These inputs help the issue detector to quickly identify and prioritize issues that require immediate attention. Detected issues are logged in Data Lake 1220 by Issue Detector 1402, ensuring that all incidents are recorded for future analysis and reference. This helps in understanding the frequency and nature of issues, aiding in continuous improvement.

Once an issue is detected, it is sent to the remediation into, which automatically applies predefined remediation actions to resolve the issue. Remediation Engine 1404 ensures that these actions are executed correctly and efficiently, minimizing downtime and impact on the system.

In addition to Remediation Engine 1404, an application, Self-healing Module Detection 1406, identifies deployment issues and applies self-healing measures to correct them. Self-healing Module Detection 1406 continuously monitors the system to ensure it remains healthy and operational, using AI algorithms to determine and apply the most effective self-healing actions. Remediation Engine 1404 sends remediation changes to the request handler for further processing and implementation. This feedback loop helps in refining and improving the remediation actions based on past performance and outcomes.

Automated Detection and Remediation Engine 1400 is a critical component of the multi-cloud management platform 100A/100B, responsible for autonomously detecting and resolving issues within the cloud infrastructure. Each component within this application plays a vital role in ensuring the stability, performance, and security of the system. By continuously monitoring data, detecting issues, applying remediation actions, and implementing self-healing measures, Automated Detection and Remediation Engine 1400 helps maintain a robust and resilient cloud environment. The use of advanced AI and ML techniques enhances the efficiency and effectiveness of issue detection and remediation, ensuring that the multi-cloud management platform 100A/100B remains reliable and capable of handling the complexities of modern cloud infrastructure management.

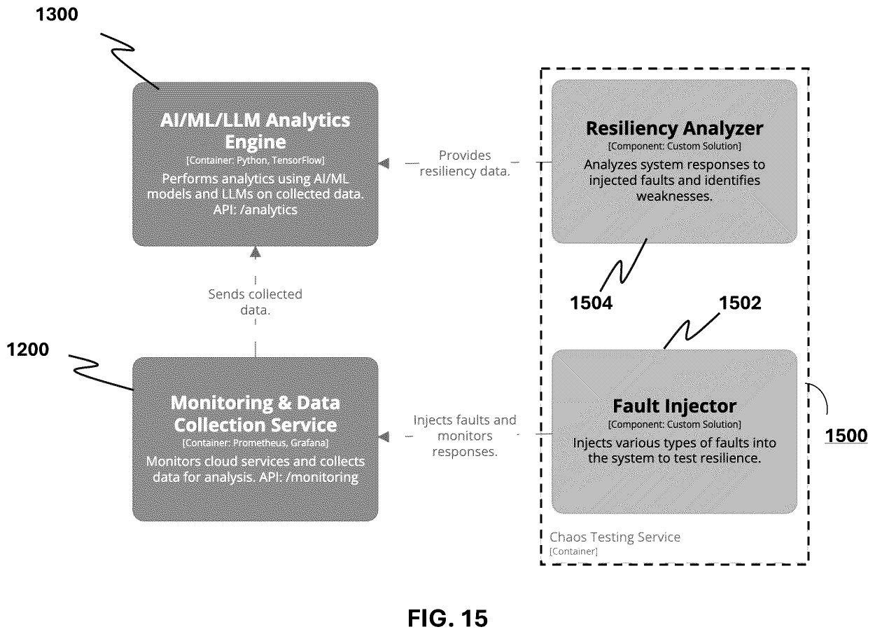

FIG. 15 illustrates an exemplary chaos testing service application in accordance with the embodiments. This application, Chaos Testing Service 1500, within multi-cloud management platform 100A/100B is designed to proactively test the resilience and stability of the cloud infrastructure by injecting faults and monitoring the system's responses. This application helps in identifying weaknesses and improving the overall robustness of the system by simulating failure scenarios and analyzing how the system handles them. Chaos Testing Service 1500 may include several components, each responsible for specific tasks related to chaos engineering and resiliency testing including a faulty injector and a resiliency analyzer.

Fault Injector 1502 introduces deliberate faults and disruptions into a system to simulate failure scenarios and ensures that faults are injected in a controlled and safe manner to prevent unintended damage. Fault Injector 1502 uses ML models to determine the most effective fault injection points and methods based on historical data and system behavior patterns. It injects various types of faults into the system to test resilience based upon a custom solution.

Resiliency Analyzer 1504 monitors a system's responses to injected faults and disruptions, identifying weaknesses and areas for improvement in the system's resilience. This application, Resiliency Analyzer 1504, uses AI algorithms to analyze system responses, detect patterns, and provide insights into potential weaknesses and areas for improvement. It also analyzes system responses to injected faults and identifies weaknesses. Chaos Testing Service 1500 interacts with various components within the multi-cloud management platform 100A/100B to perform its functions effectively:

Internal relationships within the Chaos Testing Service 1500 include aultInjector->resiliency Analyzer “Injects faults and monitors responses.”

External relationships involving Chaos Testing Service 1500include:
1. faultInjector->dataCollector “Injects faults and monitors responses.”
2. resiliency Analyzer->anomalyDetector “Provides resiliency data.”

Within an exemplary functional workflow, in an embodiment, the fault injector is responsible for introducing deliberate faults and disruptions into the system. These faults can include network latency, server crashes, resource exhaustion, and other failure scenarios. The goal is to simulate real-world failures and observe how the system responds.

During and after fault injection, Fault Injector 1502 monitors the system's responses and collects data on how the system handles the induced faults. This data is critical for understanding the system's resilience and identifying potential weaknesses. Resiliency Analyzer 1504 analyzes the collected data to determine how effectively the system responded to the injected faults. It identifies weaknesses and areas for improvement in the system's resilience. This analysis helps in understanding the system's behavior under stress and provides insights into potential improvements.

The insights and findings from the resiliency analyzer are used to refine and improve the fault injection strategies and the overall resilience of the system. This feedback loop ensures continuous improvement in the system's ability to handle failures and disruptions.

By leveraging ML models, the fault injector can determine the most effective points and methods for fault injection. This intelligent approach ensures that the faults introduced are representative of real-world failures and provide valuable insights into the system's resilience.

Resiliency Analyzer 1504 uses AI algorithms to analyze the system's responses to injected faults. These algorithms detect patterns in the system's behavior and provide insights into potential weaknesses and areas for improvement. This advanced analysis helps in understanding the root causes of failures and improving the overall robustness of the system.

Chaos Testing Service 1500 is a crucial component of the multi-cloud management platform 100A/100B, responsible for proactively testing the resilience and stability of the cloud infrastructure. By injecting faults and monitoring the system's responses, this application helps identify weaknesses and improve the overall robustness of the system. Fault Injector 1502 and Resiliency Analyzer 1504 components work together to simulate failure scenarios, collect data, and analyze the system's behavior under stress. The use of advanced AI and ML techniques enhances the effectiveness of fault injection and resiliency analysis, ensuring that the multi-cloud management platform 100A/100B remains robust and capable of handling the complexities of modern cloud infrastructure.

Embodiments of the disclosure provide an extensible end-to-end cloud management capability designed to provide just-in-time deployable solutions for any of the major public cloud providers through its composable architecture design. This means it can quickly adapt and respond to different requirements by assembling the right components as needed, ensuring efficient and tailored solutions. This solution leverages a rich set of data from past decisions, using this historical knowledge to make better decisions in the future, supported by artificial intelligence. This capability is part of its self-healing operations, which automatically detect and fix issues, enhancing the reliability and performance of the composable architecture in a continuous loopback cycle. By continuously learning and adapting, embodiments of the present disclosure ensure that cloud environments are proactively optimized, secure, and cost-effective.

Key technical aspects and unique features of the embodiments include:
1 AI integration: the embodiments use AI and ML for real-time adjustments, optimizations, and autonomous capabilities.
2. API-Centric design: Each capability is designed with its own API, ensuring modularity, seamless integration, and customization.
3. Dynamic and autonomous infrastructure management: Incorporates AI-driven optimization, autonomous pattern generation, and self-healing mechanisms.
4. Shift-Left approach to ArchOps: Emphasizes early integration of architectural concerns in the development process.

A few of the various technological advantages provided by the embodiments include
1. Portability: Ensures that applications and workloads can move seamlessly across different cloud providers without significant reconfiguration or downtime.
2. Flexibility: Allows enterprises to leverage the best features and pricing from multiple cloud providers, avoiding vendor lock-in and reducing costs.
3. Scalability: Provides dynamic scaling and resource optimization, ensuring that the cloud infrastructure adapts to changing workloads and demands.
4. Robustness: Incorporates self-healing mechanisms and predictive analytics to maintain system stability and performance.
5. Efficiency: Shift-left to ArchOps improves efficiency by addressing architectural concerns early in the development process.
6. Reduced Operational Burden: Simplifies the management of heterogeneous cloud environments, reducing the skills gap and workload for engineers.

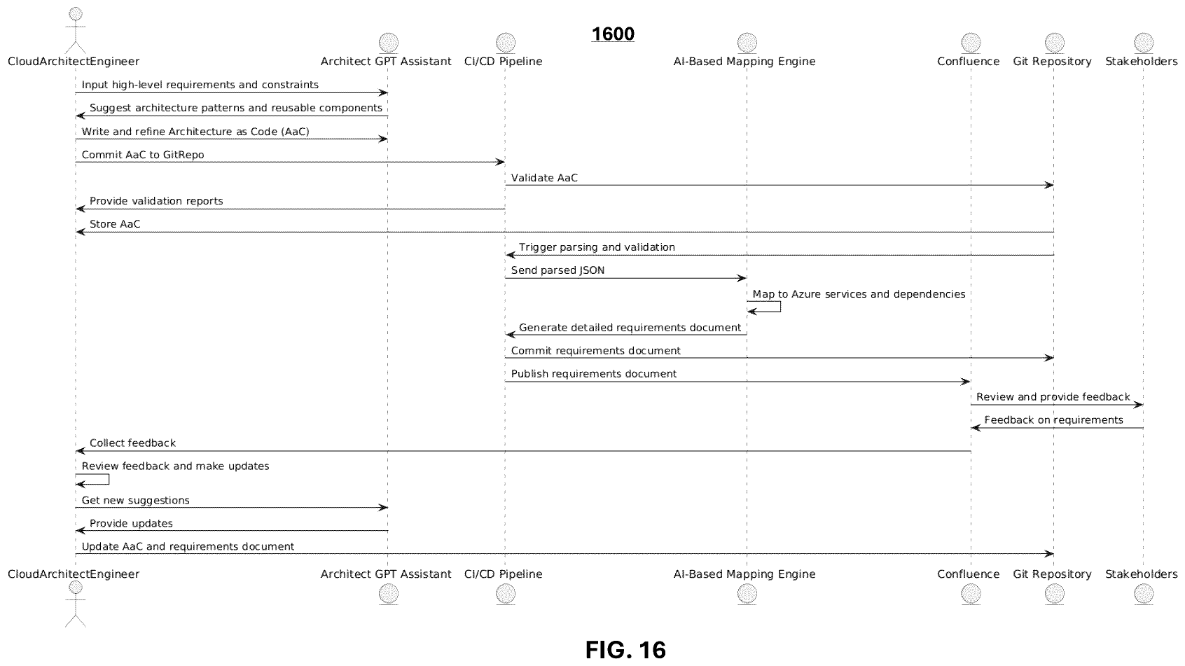

FIG. 16 illustrates a use case flow diagram 1600 of the exemplary multi-cloud management platform depicted in FIG. 1.

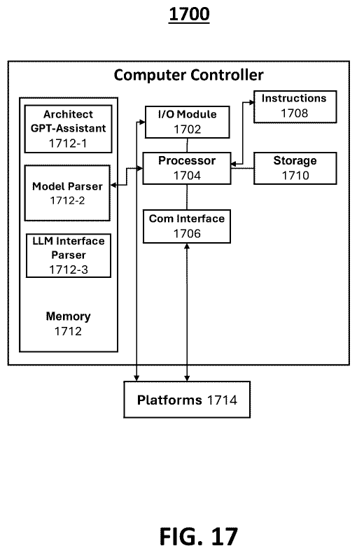

In the embodiments, FIG. 17 illustrates a computer controller 1700 that may be an application-specific hardware, software, and firmware implementation of the mainframe pipeline processes depicted in FIGS. 1-16, described above. The controller 1700 may include a processor 1704 configured to be executed on one or more, or all the blocks of the system of FIGS. 1-16, described above.

The processor 1704 can have a specific structure imparted to the processor 1704 by instructions stored in the memory 1712 and/or by instructions 1708 fetchable by the processor 1704 from a storage medium 1710. The storage medium 1710 can be remote and communicatively coupled to the controller 1700.

The controller 1700 can be a stand-alone programmable system, or a programmable module included in a larger system. For example, the controller 1700 may include or be connected to external computer systems. For example, the controller 1700 may include one or more hardware and/or software components configured to fetch, decode, execute, store, analyze, distribute, evaluate, and/or categorize information.

The processor 1704 may include one or more processing devices or cores (not shown). In some embodiments, the processor 1704 may be a plurality of processors, each having one or more cores. The processor 1704, in another embodiment, may be a distributed processor. The processor 1704 can execute instructions fetched from the memory 1712, i.e., with reference to, among other code, instructions, or data, one of memory modules 1712-1, 1712-2, or 1712-3. Alternatively, the instructions can be fetched from the storage medium 1710, or from a remote device connected to the controller 1700 via the communication interface 1706.

Furthermore, the communication interface 1706 can also interface with processors within a computer system of the mainframe pipeline architecture. An input/output (I/O) module 1702 may be configured for additional communications to or from associated local and/or remote systems of one or more platforms 1714, such as the multi-cloud management platform 100A/100B of FIGS. 1-16.

Without loss of generality, the storage medium 1710 and/or the memory 1712 can include a volatile or non-volatile, magnetic, semiconductor, tape, optical, removable, non-removable, read-only, random-access, or any type of non-transitory computer-readable computer medium. The storage medium 1710 and/or the memory 1712 may include programs and/or other information usable by processor 1704. Furthermore, the storage medium 1710 can be configured to log data processed, recorded, or collected during the operation of the controller 1700.

The data may be time-stamped, location-stamped, cataloged, indexed, encrypted, and/or organized in a variety of ways consistent with data storage practice. The memory modules in memory 1712 may represent specialized modules for various functions described in the embodiments herein.

By way of example, the memory module 1712-1 may represent a specialized module configured to implement aspects of the AGPT-Assistant described above. Similarly, the memory module 1712-2 may form the model parser, and the memory module 1712-3 may form the LLM interface parser, as described with reference to one or more of FIGS. 1-16, described above. The instructions embodied in these memory modules can cause the processor 1704 to perform certain operations consistent with the functions described above.

The processor 1704 is a hardware device for executing software, particularly that stored in memory 1712. The processor 1704 can be any custom made or commercially available processor, a central processor unit (CPU), an auxiliary processor among several processors associated with the computer controller 1700, a semiconductor based microprocessor (in the form of a microchip or chip set), a macroprocessor, or generally any device for executing software instructions.

The memory 1712 can include any one or combination of volatile memory elements (e.g., random access memory (RAM, such as DRAM, SRAM, SDRAM, etc.)) and nonvolatile memory elements (e.g., ROM, erasable programmable read-only memory (EPROM), electronically erasable programmable read-only memory (EEPROM), programmable read-only memory (PROM)).

Memory 1712 may also include removable storage such as tape, compact disc read-only memory (CD-ROM), disk, diskette, cartridge, cassette or the like, etc., and non-removable storage such as a hard disk drive (HDD).

Moreover, the memory 1712 may incorporate electronic, magnetic, optical, and/or other types of storage media. Note that the memory 1712 can have a distributed architecture, where various components are situated remotely from one another, but can be accessed by the processor 1704.

The software in memory 1712 may include one or more separate programs, each of which comprises an ordered listing of executable instructions for implementing logical functions, and a suitable operating system (OS). The OS essentially controls the execution of the computer programs and provides scheduling, input-output control, file and data management, memory management, communication control, and related services.

If the computer controller 1700 is a PC, workstation, intelligent device, or the like, the software in the memory 1712 may further include a basic I/O system (BIOS), omitted from this description for simplicity. The BIOS is a set of essential software routines that initialize and test hardware at startup, start the OS, and support the transfer of data among the hardware devices. The BIOS is stored in read-only memory (ROM) so that the BIOS can be executed when the computer controller 1700 is activated.

The disclosure provides a groundbreaking platform that solves the critical issues of vendor lock-in and operational complexity in cloud computing. By providing a unified framework for AaC, real-time composable architecture, advanced AI-driven optimization, and end-to-end self-healing capabilities, the embodiments offer a flexible, scalable, and robust solution for managing multi-cloud environments. The embodiments in power enterprises to achieve greater agility, cost-efficiency, and resilience in their cloud strategies, while reducing the operational burden on engineering teams.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed, rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A system, comprising:
an input interface;
a parser, the parser being operable to receive an architecture as code (AaC) input from the input interface in a domain-specific language (DSL) format and transform, using artificial intelligence (AI)/machine learning (ML), the AaC input into a structured human-readable computer language of a different format;
a generative pre-trained (GPT) transformer coupled to the parser, the GPT transformer being trained on architectural data; the GPT transformer being operable to assist in the creation of architecture as code (AaC);
a detection and remediation engine being operable to detect one or more anomalies or performance issues within the system;
a repository for storing one or more code templates, relating to the one or more anomalies or performance issues, pertaining to infrastructure of the system;
a mapping engine being operable to decompose, match and merge the one or more code templates, in connection with using (AI)/(ML), into infrastructure as code (IaC); and
a deployment manager, the deployment manager being operable to make changes to enterprise network infrastructure by deploying the IaC to one or more cloud platforms.

2. The system of claim 1, wherein the mapping engine includes an AI/machine learning agent trained on a plurality of algorithms for real-time adjustments, optimizations, and autonomous infrastructure management.

3. The system of claim 1, further comprising an artificial intelligence (AI)/machine learning (ML) large language model (LLM) analytics engine, the AI/ML/LLM analytics model being coupled to detection and remediation engine, the AI/ML/LLM analytics engine being operable to provide AI/ML-based insights to the detection and remediation engine in detecting the one or more anomalies or performance issues.

4. The cloud management platform of claim 3, wherein the AI/ML/LLM analytics engine is further operable to provide predictive alerts concerning detected anomalies and issues.

5. The cloud management platform of claim 3, wherein the AI/ML/LLM analytics engine is further operable to collect and aggregate real-time data in connection with performing analytics using AI/ML models and LLMs on real-time data.

6. The system or claim 1 wherein the parser performs adaptive parsing in connection with receiving AI-based guidance from the generative pre-trained (GPT) transformer, the parser being further operable to extract metadata from the AaC of the DSL format and transform the AaC input in the DSL format into the structured human-readable computer language of the different format, using metadata.

7. The system of claim 1, wherein the deployment manager deploys the IaC to one or more cloud platforms Is through a continuous integration/continuous delivery/deployment pipeline.

8. The system of claim 1, further comprising an architect generative pre-trained transformer (GPT) Assistant, the architect GPT transformer Assistant being operable to perform self-healing operations including capturing changes in architecture as code (AaC) and forwarding those changes to the parser in an effort to lower Mean Time to Recovery (MTTR) lead times.

9. The system of claim 8, further comprising a Chaos Testing Service, the Chaos Testing Service being operable to create incidents that trigger the self-healing operations of the architect GPT transformer Assistant.

10. The system of claim 9 wherein the Chaos Testing Service is further operable to test system resilience by injecting faults into the system and analyzing responses thereto.

11. The system of claim 1, wherein the input interface includes a graphical user interface for displaying real-time system health.

12. The cloud management platform of claim 8, wherein the architect GPT Assistant is further operable to perform natural language processing (NLP) of user requests and during user interaction.

13. A method, comprising:
receiving intelligence from a generative pre-trained (GPT) transformer, the GPT transformer being trained on architectural data; the GPT transformer being operable to assist in the creation of architecture as code (AaC);
receiving the AaC, the AaC being in a domain-specific language (DSL) format;
transforming the AaC into a structured human-readable computer language of a different format;
storing one or more code templates pertaining to system infrastructure;
decomposing, matching and/or merge the one or more code templates, in connection with using artificial intelligence (AI)/machine learning (ML), into infrastructure as code (IaC); and
making changes to enterprise network infrastructure by deploying the IaC to one or more cloud platforms.

14. The method of claim 13, further comprising detecting one or more anomalies or performance issues within instantiations running on the one or more cloud platforms and reviewing, the AaC transformed into the structured human readable computer language of the different format, for approval and use.

15. The method of claim 13, wherein IaC is deployed to the one or more cloud platforms through a continuous integration/continuous delivery/deployment pipeline.

16. The method of claim 13, further comprising, collecting and aggregating real-time data in connection with performing analytics using AI/ML models and LLMs on the real-time data.

17. The method of claim 13, further comprising, perform self-healing operations including capturing changes in architecture as code (AaC) and forwarding those changes to a parser in an effort to lower Mean Time to Recovery (MTTR) lead times.

18. The method of claim 13, further comprising, creating incidents that trigger self-healing operations.

19. The method of claim 13, further comprising, injecting faults into instantiations running on the one or more cloud platforms and analyzing responses thereto.

20. The method of claim 13, further comprising, performing natural language processing (NLP) of user requests and during user interaction.
